(19) United States
(12) Patent Application Publication
(10) Pub. No.: US 2025/0137675 A1
(43) Pub. Date: May 1, 2025

(54) SYSTEMS AND METHODS FOR LEARNING AND UTILIZING OCCUPANT TOLERANCE IN DEMAND RESPONSE

(71) Applicant: Tyco Fire & Security GmbH, Neuhausen am Rheinfall (CH)

(72) Inventors: Mark Lessans, Milwaukee, WI (US); Michael J. Wenzel, Grafton, WI (US); Mark R. Reinbold, Milwaukee, WI (US); Nicole E. James, Milwaukee, WI (US); Vineet Binodshanker Sinha, Brookfield, WI (US); David A. Duncan, Milwaukee, WI (US); Rajiv Ramanasankaran, San Jose, CA (US); Michael Tenbrock, Dachsen (CH)

(21) Appl. No.: 18/930,838

(22) Filed: Oct. 29, 2024

Related U.S. Application Data
(60) Provisional application No. 63/594,269, filed on Oct. 30, 2023.

(51) Int. Cl. F24F 11/63; F24F 11/47; F24F 11/56

(52) U.S. Cl. CPC F24F 11/63; F24F 11/47; F24F 11/56

(57) ABSTRACT

A building system of a building, the building system including one or more memory devices storing instructions thereon that, when executed by one or more processors, cause the one or more processors to update a building condition of an HVAC system of a space in a building at a time t1, wherein the building condition is updated from a default building condition. The instructions when executed by the one or more processors, cause the one or more processors to update the building condition of the space at a time t2 and receive an occupant response of an occupant from the space. The instructions when executed by the one or more processors, cause the one or more processors to update an artificial intelligence (AI) model based on the occupant response and generate, using the AI model, one or more actions for the HVAC system of a plurality of spaces.

### CROSS-REFERENCE TO RELATED APPLICATIONS

The present application claims the benefit of and priority to U.S. Provisional Patent Application No. 63/594,269, filed Oct. 30, 2023, the disclosure of which is incorporated herein by reference in its entirety.

### BACKGROUND

This application relates generally to a building system of a building. This application relates more particularly to systems for managing and processing data of the building system.

### SUMMARY

At least one aspect of the disclosure relates to a method. One method includes updating, by one or more processing circuits, a building condition of an HVAC system of a space in a building at a time t1, wherein the building condition is updated from a default building condition. Further, the method includes updating, by the one or more processing circuits, the building condition of the HVAC system of the space in the building at a time t2. Further, the method includes receiving, by the one or more processing circuits from a control device, an occupant response of an occupant from the space corresponding with the building condition. Further, the method includes updating, by the one or more processing circuits, an artificial intelligence (AI) model based on the occupant response. Further, the method includes generating, by the one or more processing circuits using the AI model, one or more actions for the HVAC system of a plurality of spaces of the building.

In some embodiments, the one or more actions include at least one of updating an operating parameter of the HVAC system for at least a space of the plurality of spaces, updating an operating condition of the HVAC system for at least a space of the plurality of spaces, updating an occupancy schedule of the building.

In some embodiments, the AI model includes a generative large language model (LLM), and wherein the generative LLM includes a pretrained generative transformer model.

In some embodiments, the building condition includes at least one of a temperature setpoint of the space, a level of lighting in the space, an air quality metric of the space, ventilation of the space, a humidity setpoint of the space, an outdoor air fraction of the space.

In some embodiments, the occupant response received from the control device is received from at least one of a thermostat in the space or an application on a mobile device.

In some embodiments, the method further includes in response to receiving the occupant response, presenting, by the one or more processing circuits via a generative AI model on the control device, a prompt corresponding to the building condition, receiving, by the one or more processing circuits via the generative AI model on the control device, an acceptance of the building condition, and maintaining, by the one or more processing circuits, the building condition of the HVAC system of the space in the building at a time t3.

In some embodiments, the method further includes prompting, by the one or more processing circuits via the generative AI model on the mobile device, the occupant to reduce a building load including one or more recommendations to reduce the building load.

In some embodiments, the method further includes collecting or receiving, by the one or more processing circuits, a plurality of unstructured data corresponding to a plurality of occupant responses associated with one or more building conditions of the plurality of spaces in the building and training, by the one or more processing circuits, the AI model using the plurality of unstructured data, wherein updating the AI model includes retraining the AI model based on the occupant response.

In some embodiments, the plurality of occupant responses includes a plurality of tolerance responses of the plurality of occupants of the building associated with a setpoint of at least one of the plurality of spaces of the building.

In some embodiments, the method further includes in response to receiving the occupant response, generating, by the one or more processing circuits using the AI model, one or more actions for the HVAC system corresponding with updating the building condition.

In some embodiments, the method further includes updating, by the one or more processing circuits, a second building condition of the HVAC system of a second space in the building at a time t4, wherein the second building condition is updated from the default building condition. In some embodiments, the method further includes updating, by the one or more processing circuits, the second building condition of the HVAC system of the space in the building at a time t5. In some embodiments, the method further includes updating, by the one or more processing circuits, the second building condition of an HVAC system of the space in the building at a time t6. In some embodiments, the method further includes receiving, by the one or more processing circuits from a control device, a second occupant response of a second occupant from the second space corresponding with the second building condition. In some embodiments, the method further includes updating, by the one or more processing circuits, the AI model based on the second occupant response.

At least one aspect of the disclosure relates to a building system of a building, the building system including one or more memory devices storing instructions thereon that, when executed by one or more processors, cause the one or more processors to update a building condition of an HVAC system of a space in a building at a time t1, wherein the building condition is updated from a default building condition. The instructions when executed by the one or more processors, cause the one or more processors to update the building condition of the HVAC system of the space in the building at a time t2. The instructions when executed by the one or more processors, cause the one or more processors to receive, from a control device, an occupant response of an occupant from the space corresponding with the building condition. The instructions when executed by the one or more processors, cause the one or more processors to update an artificial intelligence (AI) model based on the occupant response. The instructions when executed by the one or more processors, cause the one or more processors to generate, using the AI model, one or more actions for the HVAC system of a plurality of spaces of the building.

In some embodiments, the one or more actions include at least one of updating an operating parameter of the HVAC system for at least a space of the plurality of spaces, updating an operating condition of the HVAC system for at least a space of the plurality of spaces, updating an occupancy schedule of the building.

In some embodiments, the AI model includes a generative large language model (LLM), and wherein the generative LLM includes a pretrained generative transformer model.

In some embodiments, the building condition includes at least one of a temperature setpoint of the space, a level of lighting in the space, an air quality metric of the space, ventilation of the space, a humidity setpoint of the space, an outdoor air fraction of the space.

In some embodiments, the occupant response received from the control device is received from at least one of a thermostat in the space or an application on a mobile device.

In some embodiments, the instructions when executed by the one or more processors, cause the one or more processors to in response to receiving the occupant response, present, via a generative AI model on the control device, a prompt corresponding to the building condition, receive, via the generative AI model on the control device, an acceptance of the building condition, maintain the building condition of the HVAC system of the space in the building at a time t3.

In some embodiments, the instructions when executed by the one or more processors, cause the one or more processors to prompt, via the generative AI model on the mobile device, the occupant to reduce a building load including one or more recommendations to reduce the building load.

In some embodiments, the instructions when executed by the one or more processors, cause the one or more processors to collect or receive a plurality of unstructured data corresponding to a plurality of occupant responses associated with one or more building conditions of the plurality of spaces in the building and train the AI model using the plurality of unstructured data, wherein updating the AI model includes retraining the AI model based on the occupant response.

At least one aspect of the disclosure relates to a non-transitory computer readable medium storing instructions thereon that, when executed by one or more processors, cause the one or more processors to update a building condition of an HVAC system of a space in a building at a time t1, wherein the building condition is updated from a default building condition, update the building condition of the HVAC system of the space in the building at a time t2, receive, from a control device, an occupant response of an occupant from the space corresponding with the building condition, update an artificial intelligence (AI) model based on the occupant response, and generate, using the AI model, one or more actions for the HVAC system of a plurality of spaces of the building.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for occupant tolerance response applications.

FIG. 2 is a block diagram of an example of a language model-based system for occupant tolerance response applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of implementing generative artificial intelligence architectures and validation processes for machine learning algorithms for building management systems.

FIG. 9 is a flow diagram of a method of implementing artificial intelligence architectures and validation processes for generating an action for an HVAC system in response to a building condition.

### DETAILED DESCRIPTION

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can be implemented to more precisely generate data for various applications including, for example and without limitation, receiving an occupant response from an occupant of a space; generating actions for an HVAC system in the building, updating an operating parameter of the HVAC system; presenting a prompt in response to receiving the occupant response; recommendations of actions to be performed to reduce building load; and/or recommendations for tolerance responses to reduce building load. Various such applications can facilitate both asynchronous and real-time occupancy responses and HVAC operating conditions, including by generating text data for such applications based on data from disparate data sources that cannot have predefined database associations amongst the data sources, yet can be relevant at specific steps or points in time during HVAC operating conditions.

In some systems, occupancy responses can be supported by text information, such as predefined text documents such as building load, and/or HVAC operation guides. Various such text information cannot be useful for specific occupancy responses and/or HVAC operations. For example, the text information can correspond to different building parameters, such as lighting levels, that are not affected by occupancy responses. The text information, being predefined, cannot account for specific technical issues that can be present in the HVAC operations.

AI and/or machine learning (ML) systems, including but not limited to LLMs, can be used to generate text data and data of other modalities in a more responsive manner to real-time conditions, including generating strings of text data that cannot be provided in the same manner in existing documents, yet can still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations can limit the ability of such systems to precisely generate appropriate data for specific conditions. For example, due to the predictive nature of the generated data, some LLMs can generate text data that is incorrect, imprecise, or not relevant to the specific conditions. Using the LLMs can require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits can require increased computational processing, API calls to LLM services, and/or memory usage), limiting the ability of the LLMs to be effectively configured or operated using large amounts of raw data or otherwise unstructured data. In some instances, relatively large LLMs, such as LLMs having billions or trillions of parameters, can be less agile in responding to novel queries or applications. In addition, various LLMs can lack transparency, such as to be unable to provide to a user a conceptual/semantic-level explanation of a given output was generated and/or selected relative to other possible outputs.

In some embodiments, a machine learning (ML) model can include various learning architectures (e.g., networks, backbones, algorithms, etc.), including but not limited to language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof. The ML model can also include various artificial intelligence model architectures (e.g., linear regression, deep neural networks, logistic regression, decision trees, linear discriminant analysis, naive bayes, support vector machines, learning vector quantization, k-nearest neighbors, or random forest).

At least one aspect relates to a system. The system can include one or more processors configured to receive training data. The training data can include at least one of a structured data or unstructured data. The system can apply the training data as input to at least one method of artificial intelligence. Responsive to the input, the at least one method of artificial intelligence can generate a candidate output. The system can evaluate the candidate output relative to the training data, and update the at least one method of artificial intelligence responsive to the evaluation.

At least one aspect relates to a method. The method can include receiving, by one or more processors, training data. The training data can include at least one of a structured data or unstructured data. The method can include applying, by the one or more processors, the training data as input to a method of artificial intelligence. The method can include generating, by the method of artificial intelligence responsive to the input, a candidate output. The method can include evaluating the candidate output relative to the training data. The method can include updating the at least one method of artificial intelligence responsive to the evaluation.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can facilitate real-time messaging and/or conversational interfaces for users to provide field data regarding equipment to the system (including presenting targeted queries to users that are expected to elicit relevant responses for efficiently receiving useful response information from users) and guide users, such as building occupants, through relevant processes such as setting a tolerance response.

This can include, for example, receiving data from user tolerance responses in various formats, including various modalities and/or multi-modal formats (e.g., text, speech, audio, image, and/or video). The system can facilitate automated, flexible report generation, such as by processing information received from users into a standardized format, which can reduce the constraints on how the user submits data while improving resulting reports. The system can couple unstructured data to other input/output data sources and analytics, such as to relate unstructured data with outputs of timeseries data from equipment (e.g., sensor data; report logs) and/or outputs from models or algorithms of equipment operation, which can facilitate more accurate analytics, prediction responses, diagnostics, and/or fault detection. The system can perform classification or other pattern recognition or trend detection operations to facilitate more timely the modulation of a setpoint, a prediction of a user response, and/or a prediction of a tolerance level. The system can perform root cause prediction by being trained using data that includes indications of root causes of user responses or setpoint modulations, where the indications are labels for or otherwise associated with (unstructured or structure) data. The system can receive, from a user in the building, feedback regarding the accuracy of the root cause predictions, as well as feedback regarding how the user evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for modulating HVAC operating parameters in response to user inputs in which a machine learning model is configured based on connecting or relating unstructured data and/or semantic data, such as human feedback and written/spoken reports, with time-series product data regarding items of equipment, so that the machine learning model can more accurately detect HVAC setpoint modulations or other events that can trigger user responses. For example, responsive to a user increasing the temperature in an office, the system can more accurately detect a temperature at which the user will increase the setpoint, and generate a prescription for responding to the user input; the system can request feedback from the user regarding the prescription, such as whether the prescription correctly identified the cause of the setpoint modulation and/or actions to perform to respond to the modulation, as well as the information that the user used to evaluate the correctness or accuracy of the prescription; the system can use this feedback to modify the machine learning models, which can increase the accuracy of the machine learning models. In some embodiments, the system can predict the user response (e.g., detect an indication of the user modulating the setpoint prior to the user modulation occurring). The system can determine one or more actions to perform to prevent the user response from occurring, such as modifications to HVAC operating parameters, or preventative actions. The system can generate a report, responsive to predicting the user response, that identifies the one or more actions.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying user responses, causes of user responses, and other accurate expert knowledge regarding building load reduction) from the unstructured data in order to use both the unstructured data and the data relating to equipment operation to generate more accurate outputs regarding user preferences. As such, by implementing language models using various operations and processes described herein, building management and occupant tolerance systems can take advantage of the causal/semantic associations between the unstructured data and the data relating to equipment operation, and the language models can allow these systems to more efficiently extract these relationships in order to more accurately predict targeted, useful information for tolerance applications at inference-time/runtime. While various embodiments are described as being implemented using generative AI models such as transformers and/or GANs, in some embodiments, various features described herein can be implemented using non-generative AI models or even without using AI/machine learning, and all such modifications fall within the scope of the present disclosure.

The system can employ a generative AI-based wizard interface. For example, the interface can include user interface and/or user experience features configured to provide a question/answer-based input/output format, such as a conversational interface, that directs users through providing targeted information for accurately generating predictions of user responses, presenting solutions, or presenting instructions for modulating HVAC operating parameters to identify information that the system can use to detect user responses or building load reduction. The system can use the interface to present information regarding parts and/or tools to reduce building load, as well as instructions for how to use the parts and/or tools to reduce the building load.

In various embodiments, the systems can include a plurality of machine learning models that can be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model. In various embodiments, the machine learning models can be logically and/or physically distributed, interact, and/or be orchestrated by a second machine learning model to achieve the targeted outcome(s). In various embodiments, the first machine learning models are central.

The system can be used to automate interventions for equipment operation, setpoint modulation, and building load reduction. For example, by being configured to perform operations such as root cause prediction, the system can monitor data regarding equipment to predict events associated with user responses such as setpoint modulation or tolerance level modulation. The system can present to a user a report regarding the intervention (e.g., action taken responsive to predicting a fault or root cause condition) and requesting feedback regarding the accuracy of the intervention, which can be used to update the machine learning models to more accurately generate interventions.

### I. Machine Learning Models for Building Management and Learning and Utilizing Occupant Tolerance in Demand Response

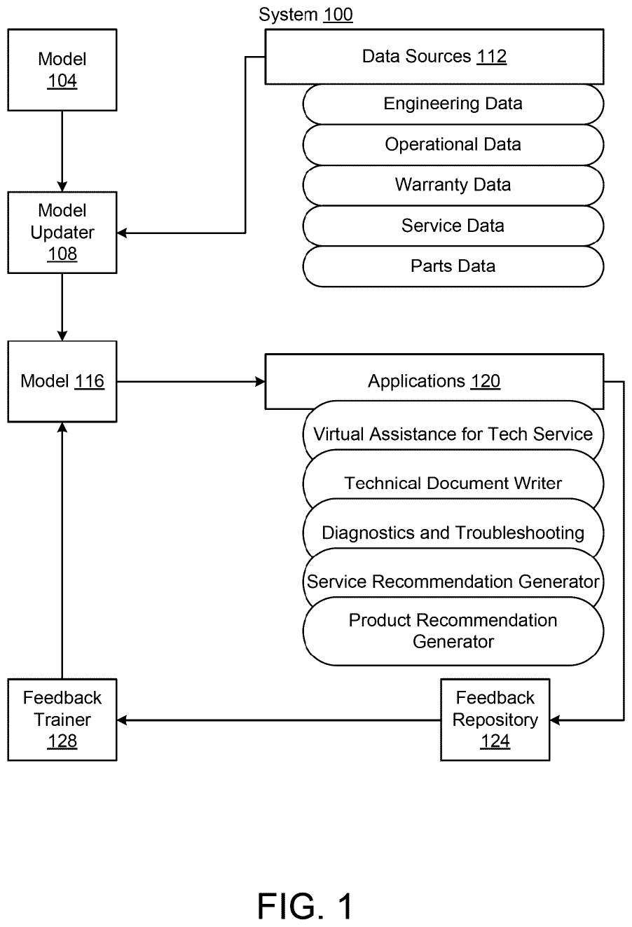

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based or general AI-based building occupancy responses. While various embodiments are described as being implemented using generative AI models such as transformers and/or GANs, in some embodiments, various features described herein can be implemented using non-generative AI models (i.e., general AI) or even without using AI/machine learning, and all such modifications fall within the scope of the present disclosure.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory) and/or non-transitory computer readable medium(s). The processors can be a general purpose or specific purpose processors, an application specific integrated circuit (ASIC), one or more field programmable gate arrays (FPGAs), a group of processing components, or other suitable processing components. The processors can be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and can have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning and Artificial Intelligence Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which can be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof. While various embodiments are described as being implemented using generative AI models such as transformers and/or GANs, in some embodiments, various features described herein can be implemented using non-generative (or general) AI models or even without using AI/machine learning, and all such modifications fall within the scope of the present disclosure.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some embodiments, the first model 104 includes a plurality of generative models, such as GPT and diffusion models, or general models, that can be trained separately or jointly to facilitate generating multi-modal outputs, such as technical documents (e.g., service guides) that include both text and image/video information.

In some embodiments, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a change in a user tolerance level, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some embodiments, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some embodiments, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some embodiments, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some embodiments, the first model 104 and the second model 116 each include generative AI machine learning models, such as LLMs (e.g., GPT-based LLMs) and/or diffusion models. The second model 116 can be configured using processes analogous to those described for configuring the first model 104.

In some embodiments, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some embodiments, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 can be provided in the same or different data elements, and can be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers, or is in a predetermined format, such as a database or tabular format). The unstructured data can include one or more data elements that are not in a predetermined format (e.g., are not assigned to fields, or labeled with or assigned with identifiers, that are indicative of a characteristic of the one or more data elements). The data sources 112 can include semi-structured data, such as data assigned to one or more fields that can not specify at least some characteristics of the data, such as data represented in a report having one or more fields to which freeform data is assigned (e.g., a report having a field labeled “describe the item of equipment” in which text or user input describing the item of equipment is provided). The data sources 112 can include data that is incomplete,

For example, using the first model 104 and/or second model 116 to process the data can allow the system 100 to extract useful information from data in a variety of formats, including unstructured/freeform formats, which can allow users to input (or response) information in less burdensome formats. The data can be of any of a plurality of formats (e.g., text, speech, audio, image, video, etc.), including multi-modal formats. For example, the data can be received from users in forms such as text (e.g., laptop/desktop or mobile application text entry), audio, and/or video (e.g., dictating findings while capturing video).

The data sources 112 can include setpoint data regarding data about a setpoint of a component of an HVAC system. The setpoint data can include what setpoint the system is currently operating at, if a user has adjusted a setpoint, or by how much a setpoint has been modulated in a given time period. The setpoint data can include, for example, a temperature of a building space, a humidity level of a space, a brightness of a light, or indoor air quality metric.

In some embodiments, the data sources 112 can include tolerance data regarding one or more users' tolerance levels. The tolerance data can represent an individual user's preferences about building or space-specific HVAC setpoints. The tolerance data can include a maximum and/or a minimum tolerance level, a mean tolerance level, or a range of tolerance levels.

The data sources 112 can include, for example, user data. User data can include user preferences such as a range of temperatures preferred by the user. Additionally, user data can include profile information indicative of the user's habitual patterns and regular interactions with the HVAC system, which can encompass typical times of adjusting setpoints, favored light levels during specific times of the day, and preferred air quality standards. For example, an individual can generally prefer a slightly cooler room during the evening hours, or have a penchant for dimmer lighting during work hours to reduce glare on their computer screen.

The data sources 112 can include occupancy data. Occupancy data can include the number of individuals in a specific space or zone of a building. Occupancy data can be dependent on factors such as time of day, day of the week and/or season.

In some embodiments, the data sources 112 can include building data. Building data can include, for example, the location of the building, the size of the building, and/or the floorplans of the building. Additionally, the building data can also include the load of the building, the energy usage of the building, and/or other sustainability markers of the building.

The system 100 can include, with the data of the data sources 112, labels to facilitate cross-reference between items of data that can relate to common items of HVAC equipment, building spaces, users, or various combinations thereof. For example, data from disparate sources can be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some embodiments, the data includes labels or identifiers of such information, such as to indicate locations, weather conditions, timing information, uses of the items of equipment or the buildings or sites at which the items of equipment are present, etc. This can allow the models 104, 116 to detect patterns of usage (e.g., spikes; troughs; seasonal or other temporal patterns) or other information that can be useful for determining user setpoints, user tolerances, building load, or predict future setpoints or energy usage, such as to allow the models 104, 116 to be trained using information indicative of causes of energy or setpoint changes across multiple users or building spaces (which can have the same or similar changes even if the data regarding the items of equipment is not identical). For example, a user can be at a building location that is east facing at a high level of altitude; by relating usage or occupancy data with data regarding the building, the system 100 can configure the models 104, 116 to determine a high likelihood of energy changes occurring before events associated with energy changes (e.g., change in season, time of sunrise), and can generate recommendations to perform setpoint changes prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some embodiments, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some embodiments, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some embodiments, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some embodiments, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., setpoint data, tolerance data, and building data) for the HVAC setpoint modulation application 120. The model updater 108 can apply various combinations of data from various data sources 112 to facilitate configuring the second model 116 for one or more applications 120.

In some embodiments, the system 100 can perform at least one of conditioning, classifier-based guidance, or classifier-free guidance to configure the second model 116 using the data from the data sources 112. For example, the system 100 can use classifiers associated with the data, such as identifiers of the user, a location of the HVAC system, or a space of the building, to condition the training of the second model 116. For example, the system 100 combine (e.g., concatenate) various such classifiers with the data for inputting to the second model 116 during training, for at least a subset of the data used to configure the second model 116, which can allow the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some embodiments, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof.

The applications 120 can include user interfaces, dashboards, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, and generate reports in a standardized format, such as a customer-specific format. This can allow, for example, users to automatically, and flexibly, generate reports after setpoint adjustments without requiring strict input by the user; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some embodiments, the applications 120 include at least one user tolerance modulation application 120. The user tolerance modulation application 120 can receive information regarding a user response to an element of an HVAC system, such as an adjustment to a setpoint and process the received information using the second model 116 to generate corresponding responses. A corresponding response can include, for example, a prediction of a user's tolerance levels based on the user responses.

The applications 120 can include at least one HVAC setpoint modulation application 120. The HVAC setpoint modulation application 120 can modulate setpoints for various HVAC operating parameters, such as temperature, air quality, and/or light levels. For example, the HVAC setpoint modulation application 120 can increase or decrease the brightness of lights in an office space based on the time of day. The HVAC setpoint modulation application 120 can use inputs, such as prompts received from the users, to generate a change in a setpoint. For example, the HVAC setpoint modulation application 120 can provide the inputs to the second model 116 to cause the second model 116 to increase or decrease the temperature in a user's office based on an input from the user.

The applications 120 can include at least one load reduction application 120. The load reduction application 120 can receive inputs including at least one of a user tolerance level or information regarding the energy usage of the building. The load reduction application 120 can provide the inputs to a corresponding second model 116 to cause the second model 116 to generate outputs such as indications of potential actions to be taken by users to reduce the load of the building, modifications to make to reduce the load, or values or ranges of values of parameters of the building that can be indicative of a load reduction of the building or reduction of energy usage.

The applications 120 can include at least one user setting recommendation generator application 120. The user setting recommendation generator application 120 can receive inputs such as a user tolerance level or user preference, and provide the inputs to the second model 116 to cause the second model 116 to generate outputs for presenting user setting recommendations, such as actions to perform to reduce building load while maintaining a level of user comfort.

In some embodiments, the applications 120 can include a user message delivery application 120. The user message delivery application 120 can process inputs such as user setpoint modulation, using one or more second models 116 (e.g., models trained using parts data from the data sources 112), to determine a message to deliver to a user indicating the effects the user setpoint modulation has on the building load.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some embodiments, the system 100 stores the feedback with one or more data elements associated with the feedback, including but not limited to the outputs for which the feedback was received, the second model(s) 116 used to generate the outputs, and/or input information used by the second models 116 to generate the outputs.

The feedback trainer 128 can update the one or more second models 116 using the feedback. The feedback trainer 128 can be similar to the model updater 108. In some embodiments, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some embodiments, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

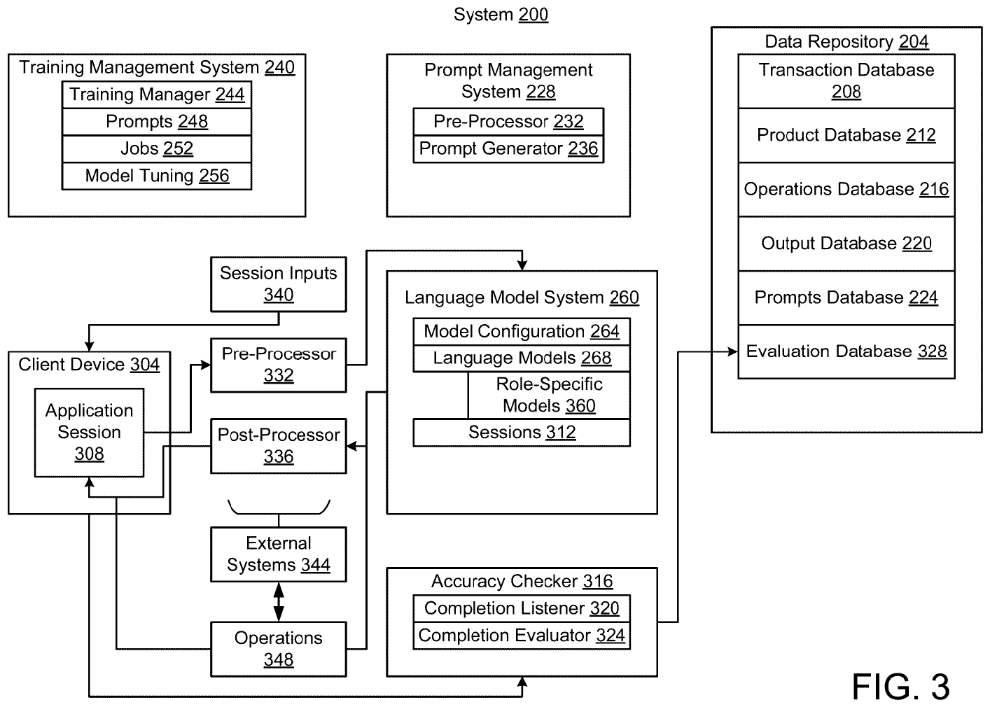

In some embodiments, the system 100 cannot include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### II. System Architectures for AI Applications for Building Management System and Learning and Utilizing Occupant Tolerance in Demand Response

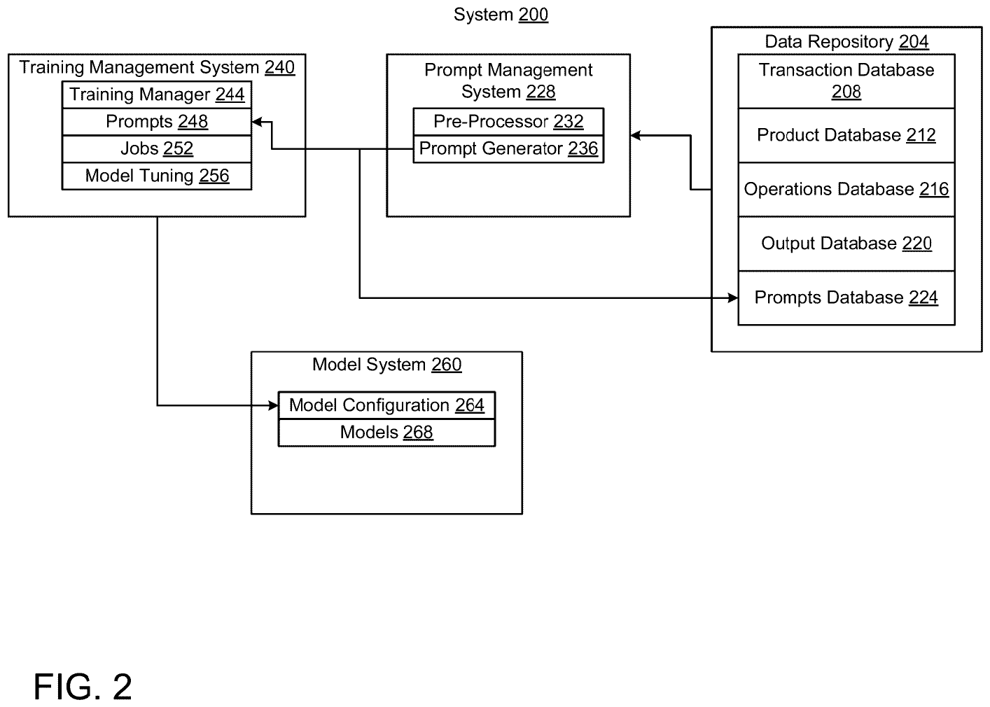

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to allow AI applications for building managements systems and occupancy response, such as various manners of processing input data into training data (e.g., tokenizing input data; forming input data into prompts and/or completions), and managing training and other machine learning model configuration processes. Various components of the system 200 can be implemented using one or more computer systems, which can be provided on the same or different processors (e.g., processors communicatively coupled via wired and/or wireless connections). While various embodiments are described as being implemented using generative AI models such as transformers and/or GANs, in some embodiments, various features described herein can be implemented using non-generative AI models or even without using AI/machine learning, and all such modifications fall within the scope of the present disclosure.

The system 200 can include at least one data repository 204, which can be similar to the data sources 112 described with reference to FIG. 1. For example, the data repository 204 can include a transaction database 208, which can be similar or identical to one or more of tolerance data or occupancy data of data sources 112. For example, the transaction database 208 can include data such as tolerance levels for individual building occupants; setpoint data indicating setpoint modulations of the building HVAC system; building and/or occupancy data elements of the building and the occupants of the building; and user data.

The data repository 204 can include a product database 212, which can be similar or identical to the parts data of the data sources 112. The product database 212 can include, for example, data regarding products available from various vendors, specifications or parameters regarding products, and indications of products used for various HVAC operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding HVAC systems, products, and/or items of HVAC equipment; user data; and or reports, such as building energy use logs.

In some embodiments, the data repository 204 can include an output database 220, which can include data of outputs that can be generated by various machine learning models and/or algorithms. In various embodiments, first machine learning models can be logically and/or physically distributed, interact, and/or be orchestrated by a second machine learning model to achieve the targeted outcome(s). In various embodiments, the first machine learning model can be central. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 204, and determine training data elements that include examples of input and outputs for generation by machine learning models, such as a training data element that includes a prompt and a completion corresponding to the prompt, based on the data from the data repository 204.

In some embodiments, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some embodiments, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some embodiments, the prompt generator 236 automatically determines prompts and completions from data of the data repository 204, such as by using any of various natural language processing algorithms to detect prompts and completions from data. In some embodiments, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some embodiments, the training management system 240 includes a prompts dataset 248. The prompts dataset 248 can be stored locally and/or in prompts database 224. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some embodiments, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some embodiments, the training management system 240 implements the model system 260. In some embodiments, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts dataset 248 other prompt data stored in prompts database 224 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various embodiments, the system 200 can use the training management system 240 to configure the machine learning models 268 in a similar manner as described with reference to the second model 116 of FIG. 1, such as to train the machine learning models 268 using any of various data or combinations of data from the data repository 204.

### Sustainability Embodiments

In some embodiments, the model system 260 can implement one or more models (e.g., LLMs, rule based, machine learning, artificial intelligence, neural networks, graphs, vectors, linear regression, deep neural networks, logistic regression, decision trees, linear discriminant analysis, naive bayes, support vector machines, learning vector quantization, k-nearest neighbors, or random forest) to output a determination of how much load (e.g., HVAC system) can be reduced based on an occupancy response to improve building efficiency. References to artificial intelligence, machine learning, models, and/or model systems made herein can refer to any type of artificial intelligence as it relates to the systems and methods illustrated in the exemplary embodiments. The modeling can include modulating setpoint tolerances and using the response to determine what conditions (e.g., temperature, humidity, indoor air quality metrics, lighting) users in the space can tolerate. Accordingly, the modeling can be implemented to improve building efficiency. Examples of setpoints include, but are not limited to, the temperature of the space, levels of lighting, air flow, air quality metrics, and ventilation. In some embodiments, the load in the building can be reduced using various techniques implemented by model system 260 and delivered by system 200. For example, the techniques can include updating setpoints or zone controls, utilizing a heat pump, adjusting start and stop times, implementing demand control ventilation (DCV), optimizing supply air temperature, etc. In some embodiments, when adjusting the setpoint, it can be incrementally adjusted (e.g., increased or decreased). In some embodiments, the setpoint is incrementally adjusted according to a time period (e.g., every 10 minutes, every hour, every four hours, every eight hours, daily, etc.).

In some embodiments, training data can be collected by adjusting the setpoint until the setpoint reaches a level corresponding to a maximum tolerance or a minimum tolerance. In various embodiments, the maximum tolerance and minimum tolerance are each determined by the individual(s) in the space. In some embodiments, the tolerances can also be context specific. For example, a context can be the day of the week (e.g., Monday or Wednesday), the time of the year (e.g., summer or winter), environmental health information (e.g., presence of pathogens, community spread data, etc.), user health information (e.g., current health conditions, gender, etc.). Accordingly, each individual in the space can have their own tolerances that are stored in the memory of model system 260. The individual(s) in the space can interact with the model system 260 and system 200 by responding to the incremental adjustments made to the setpoint. The individual(s) in the space can interact with model system 260 and system 200 via the wall thermostat in the space, or via an application on the user's mobile device. For example, an individual can submit a ticket or work order indicating that the temperature in the space has been adjusted such that is past the individual's maximum or minimum tolerance level. One or more interactions with model system 260 by each user can be stored in memory of model system 260. In some embodiments, the individual can adjust thermostat controls or other setpoint controller to indicate that the setpoint set by the model system 260 has gone past the individual's maximum or minimum tolerance level. A user's tolerance level can be the maximum or minimum setpoint at which the user feels comfortable. If system 200 operates at a setpoint outside of the bounds set by a user's maximum and minimum tolerance levels, the user can feel uncomfortable, such as too hot or too cold, too humid or too dry, too allergenic, etc. A user's tolerance can be determined by input and responses indicative of how the user feels in the space. For example, if a user's maximum tolerance level is 73 degrees on the thermostat and model system 260 sets the temperature to 74 degrees, the user can perform a user interaction to indicate that the temperature is past their tolerance level by readjusting the thermostat to 73 degrees. A user interaction can be used as an input for model system 260 to train the model on various user tolerances across spaces and buildings. For example, a user increasing the temperature of the thermostat from 69 degrees to 70 degrees can be used as an input to train model system 260 that the user's tolerance was reached and is 70 degrees. Additional context can be used as input, for example, the day of the tolerance, the time of day, other air or building characteristics (e.g., current humidity, current IAQ, etc.). In some embodiments, the space in which the system 200 controls the setpoint is a space occupied by a single individual, such as an office. In some embodiments, the space is occupied by multiple individuals, such as a grouping of cubicles or a zone of an office floor. If a space is occupied by multiple individuals, tandem recommendations about tolerances or the building's sustainability measures can be an output of model system 260. If multiple individuals are in one space in which system 200 controls the setpoint, the tolerances of all of the individuals can be considered when the optimal conditions are output from model system 260. For example, the average of all the individuals' maximum and minimum tolerances can be calculated and used as an input for training model 260, so that the output temperature satisfies all of the occupants of the space.

In general, model system 260 can train a model around the implementation and comprehension of individual temperature preferences and associated tolerance levels. In some embodiments, data is collected pertaining to an individual's preferred temperature setpoints (or other preferences such as humidity or IAQ), in conjunction with their maximum and minimum tolerance levels. This data, in some embodiments, additionally encapsulates any manual adjustments made by individuals to temperature control devices, such as thermostats. In some embodiments, subsequent to data collection, the model system 260 can preprocess the data by identifying and eliminating inconsistencies or anomalies present within the gathered data. During preprocessing, in certain embodiments, each piece of data is labeled with the pertinent tolerance levels as determined by the individual's prior interactions. For example, if a user's established maximum tolerance level is 73 degrees and they make a manual adjustment to the thermostat to reflect this preference, such an action is labeled and denoted as the user reaching their defined tolerance threshold. In some embodiments, model system 260 trains one or more models using the labeled data. The objective of this training, in various embodiments, is to facilitate the model to predict and decipher an individual's tolerance level based on their historical and real-time interactions with the system. Furthermore, in some embodiments, the model is designed to autonomously modify the setpoints in designated spaces, be it a solitary individual's office or an expansive shared zone like an area on an office floor. Accordingly, the model is trained to ascertain that the ambient conditions remain congruous with the comfort parameters set forth by its occupants.

In various embodiments, model system 260 can utilize machine learning techniques (e.g., generative AI (GAI), generative adversarial networks (GANs), deep learning methodologies, linear regression, deep neural networks, logistic regression, decision trees, linear discriminant analysis, naive bayes, support vector machines, learning vector quantization, k-nearest neighbors, random forest, etc.) to learn and determine tolerances of the users or individuals. References to artificial intelligence, machine learning, models, and/or model systems made herein can refer to any type of artificial intelligence as it relates to the systems and methods illustrated in the exemplary embodiments. In some embodiments, model system 260 can be trained to both learn tolerances and modulate the programmed settings of system 200. In some embodiments, model system 260 utilizes a baseline setpoint. In some embodiments, model system 260 can be implemented per-zone and or per-customer/user. Through iterative feedback and adjustments, model system 260 can perform experiments to learn and determine tolerances. For example, model system 260 can be trained in such a way that system 200 can implement a model that modulates the frequency with which the temperature in the space is adjusted. In some embodiments, model system 260 can be trained in such a way that system 200 can implement a model that modulates the maximum and/or minimum setpoints to which system 200 is allowed to operate. In some embodiments, model system 260 can be trained to model varying patterns of airflow delivery to understand user preferences. For example, the airflow pattern from system 200 can vary throughout the space on different days of the week or times of day and users can respond based on the comfort levels they experience based on the different airflow patterns. The model system 260 can use the results of experiments to create a tolerance map. In general, a tolerance map can track the tolerance levels of different users in each zone of the space in which the system 200 is operating. Model system 260 can create a model to determine setup needs of a space to determine the amount of load that can be shed based on a demand response signal. In some embodiments, model system 260 can optimize the outputs of the model based on occupancy. Model system 260 can train a model to democratize outputs that system 200 can implement in various spaces. Individuals occupying the space in which the experiment is being conducted can respond to the modifications or adjustments in building conditions (e.g., temperature, humidity, IAQ, lighting, etc.). Every interaction with model system 260 can be stored in memory and associated with the user performing the interaction. Model system 260 can continue to implement experiments until users respond. For example, model system 260 can decrease illumination by 10 lux per day until an occupant cannot operate in the lighting conditions and increases illumination in the space. In some embodiments, once the user responds to changes implemented by model system 260, the user can be notified of sustainability outcomes achieved by the user allowing model system 260 to implement the changes.

The model system 260 can use the user responses and outcomes of the experiments as input data (i.e., training data) for the model to learn and adjust its future actions. In some embodiments, model system 260 can learn and determine tolerances through user data inputs. For example, the model system 260 can be trained on and store records of which users override adjustments made by system 200 to learn the individual user's maximum and minimum tolerance levels, and other tolerances or preferences of the user. In some embodiments, a user's mean or average tolerance level can be determined and used as an input for model system 260. User tolerances can be stored in memory of model system 260. Users can also store multiple tolerances. For example, a user can assign a first range of setpoints corresponding to acceptable tolerance levels, a second range of setpoints corresponding to semi-acceptable tolerance levels, and/or a third range of setpoints corresponding to non-acceptable tolerance levels. In some embodiments, the user can store different types of tolerance preferences to be used as inputs for model system 260. For example, a user can have preferred temperature setpoints stored for the summer season that differ from the user's preferred temperature setpoints stored for the winter season, which model system 260 can be trained on. In some embodiments, the user or building operator can also input information about the location of the space. In some embodiments, the model system 260 can collect or retrieve building space information to determine locations of spaces without user input. For example, location information can include whether a user's office is located on the interior or exterior of the building, what floor of the building the office is on, which direction the office faces, and/or proximity to building equipment (e.g., server room, HVAC systems or units, air intakes, etc.). Users can input personal information, prior to model training or during model implementation, into system 200, for example, clothing preferences (e.g., whether the individual prefers wearing a jacket, health information (e.g., average body temperature, current medications), or other information that affects the user's specific tolerances. For example, a user can indicate if they are sensitive to the indoor air quality in the building. In some embodiments, the user input can be received via a graphical user interface of a mobile application or a web-based application. In some embodiments, the user input can be received from a thermostat or in-space controller. In various embodiments, the preferences, personal information, and tolerances of individual users are stored in memory. User data can be used as training data for model system 260. The user data can be used to optimally assign users to the space. In some embodiments, the model system 260 can train the model to assign users to spaces based on inputs received that relate to user preferences and/or tolerances. For example, model system 260 can have data input that indicates that multiple users that prefer a low temperature. Model system 260 can train the model to assign those users desks in the same cubicle grouping, in the same building space or area, in the same HVAC building zone. In some embodiments, model system 260 can make recommendations on where users working on a team can meet to satisfy user preferences. For example, model system 260 can recommend that two users collaborating on a project meet remotely if one user prefers temperatures be above 72 degrees and the second user prefers temperatures be below 68 degrees.

Additional factors can be input to train model system 260 to learn and determine tolerances. For example, weather patterns for the geographic location of the building can be used as inputs in model system 260. Previous outputs from model system 260 can be used as later inputs to model system 260. In some embodiments, constraints can be input so that model system 260 can be trained to learn and determine tolerances. Constraints can include, but are not limited to, a minimum dimness of the lighting in the space, a minimum or maximum temperature in the space, a maximum temperature in the space, a maximum humidity in the space, a desired humidity level, a desired pathogen level, a maximum or minimum outdoor/indoor mix ratio, or a maximum level of ventilation that can be removed. In some embodiments, one or more of the input constraints can have a weighting factor that model system 260 can use as inputs when training the model to learn and determine tolerances. In some embodiments, specific parameters can be flagged as unable to be modified. For example, model system 260 can be trained so that humidity levels in a hospital operating room cannot be modified. In some embodiments, model system 260 can be optimized to pair tolerance or performance settings with an event or program. For example, if a large gathering is held in a space, the number of attendees and the size of the space can be inputs for model system 260. Model system 260 can be trained to determine an optimal tolerance for the space based on the number of attendees. Additionally, model system 260 can use occupancy sensing to monitor changes in the number of people in the space as time progresses. The data can be used as an input to model system 260 to modify the tolerance levels and have system 200 deliver varying temperatures of air as the event progresses. For example, model system 260 can sense 200 occupants in a space at the start of the event and use the data so that system 200 delivers cool air. Model system 260 can use occupancy sensing two hours later to determine that 100 occupants are now in the space, so that system 200 can deliver air at a warmer temperature (or turn off the cooling, or adjust a setpoint) that improves the building's efficiency. The settings paired with the event or program can be stored in memory and retrieved so that the model system 260 can use the stored settings for multiple events over time. For example, if there is a meeting with 200 occupants in the space every Wednesday at noon, model system 260 can use the information from previous instances of the recurring meeting as an input to determine optimal tolerances for future meetings. Various other inputs can be input into model system 260, such as the cost of discomfort to users. For example, model system 260 can be trained to learn that setting the temperature to 68 degrees in a certain cubicle grouping will mean system 200 is operating outside of the tolerance range for three individuals at that cubicle grouping.

User data can be used as an input for model system 260 so the model can be trained to determine how much load can be shed or deferred based on user preferences. In some embodiments, model system 260 can provide instructions such as operating parameters and testing parameters to system 200 to perform pressure testing such that model system 260 can determine by how much the load can be reduced. In some embodiments, model system 260 can incorporate information from users or building occupants, including user tolerances and user responses to model system 260, as training data to train the model to learn about the building. For example, model system 260 can utilize occupancy sensing to be trained on how many people are in the building or space at any given time on any given day, as well as the preferences of each of those people. Model system 260 can also be trained to learn about the energy efficiency of the building and other markers of sustainability.

In various embodiments, the model trained and stored by model system 260 can include a GAI element configured to allow system 200 to execute the GAI to facilitate communication with users of the building. For example, the GAI can be provided via an API to devices operated by users of the building. The communication is facilitated by the use of GAI can be delivered via any one of a text message, e-mail, or pop-up message on an occupant dashboard. In some embodiments, model system 260 can provide information about the sustainability of the building to the building operator, individual occupants, or groups of occupants. For example, model system 260 can notify occupants that a certain sustainability outcome or goal will be met if thermostat temperatures are adjusted by a certain margin. In some embodiments, model system 260 can provide personalized recommendations to users. Recommendations can be made via a recommendation sub-model. For example, model system 260, using the recommendation sub-model, can recommend that a user allow system 200 to increase the temperature in the user's office to save energy. In another example, model system 260 can also have an output that recommends that the user allow the lights to dim during hours that the user is not in the office. In some embodiments, a demand response opportunity can be estimated by aggregating the total tolerable flex that is available in each space. Tolerable flex is determined by adjusting a setpoint until a user is no longer comfortable and responds to the adjustment, such as by adjusting the temperature on a thermostat of system 200. The user making an adjustment to system 200 can be an indicator that model system 260 was trained to learn an incorrect tolerance for the user. The setpoint at which the user responds is stored and used as an input for model system 260 to learn the user's tolerance level Tolerable flex and the demand response opportunity can be displayed to a user via a user interface.

Model system 260 can generate a comfort score for users. The comfort score can be a digital signature that is an indicator of user preferences and tolerances. The user can own their own comfort score and have the ability to transfer or bring their comfort score to other buildings or spaces that they can visit in which the technology is used (e.g., if a campus has multiple buildings). In some embodiments, model system 260 can be trained on individual user interactions with system 200. The interactions can be used as future inputs to model system 260. User interactions and user data can be used as inputs to model system 260 to generate and deliver personalized information for the user. For example, model system 260 can identify if a user has adjusted the temperature in their space such that the building now uses additional energy. Model system 260 can generate a user alert from this information that recommends that the user adjusts the temperature in the space to reduce energy usage. This can educate the user on sustainability initiatives for the building and can make the user more inclined to adjust the temperature in the space. In some embodiments, data from a user's social media account indicating the user's feelings towards sustainability can be used as an input to model system 260. In some embodiments, there is an application or web page that displays an occupant dashboard. An individual's user data can be uploaded to the occupant dashboard that corresponds to the individual user. An individualized user alert can be displayed as a message on an occupant dashboard. In some embodiments, model system 260 can provide personalized recommendations via text messages or e-mails. In some embodiments, the personalized recommendations can be delivered via a smart thermostat. For example, recommendations can be audio and/or visual. In some embodiments, a conversational artificial intelligence bot can converse with users via their occupant dashboard to collect user feedback. In some embodiments, the conversational artificial intelligence bot can communicate with a user to understand the user's reason for their tolerance setting. Depending on the reason for the tolerance level, the bot can communicate information to model system 260 and propose a different tolerance level to the user. In some embodiments, model system 260 can generate an output that delivers messages to multiple users at once via any one of an occupant dashboard messages (e.g., pop-up, text message, or e-mail). For example, model system 260 can generate an output that delivers a message to users in a cubicle grouping notifying the users that modifying the temperature will decrease energy usage in the building. In some embodiments, the occupant dashboard displays summaries, analyses, or other datapoints relating to the user. In some embodiments, users can view information about other users, such as their tolerance levels, on their occupant dashboard to push users toward greater levels of energy savings.

In some embodiments, a user can track their tolerances and preferences via the occupant dashboard on the application or web page. In some embodiments, a user can allow the system 200 to operate beyond the scope of the user tolerances to reduce the building load by indicating preferences to model system 260. Model system 260 can track these occurrences to use as future inputs to train the model. In some embodiments, a user can obtain credits for permitting system 200 to operate outside of the scope of their tolerances. For example, a user that trains model system 260 to increase the temperature of their space beyond their determined tolerance level so that the building uses less energy can receive a credit for offsetting their comfort. In some embodiments, the number of credits can correlate to parameters surrounding the reduction of building energy use. For example, allowing system 200 to operate outside of the scope of the user tolerances for a longer duration can correlate to a greater number of credits that the user receives. An individual user's credits can contribute to the overall emission credits for the building. In some embodiments, buildings that implement model system 260 can be able to obtain a certification of sustainability.

In some embodiments, model system 260 can use information from a power grid (e.g., real-time or historical) as inputs to train the model. The connection between a power grid and the model system 260 can be a two-way communicative connection. Model system 260 can also receive inputs from power companies. In some embodiments, the power gird inputs to model system 260 can be used to train model system 260 to output recommendations that increase the building's sustainability. For example, model system 260 can receive, as an input in real-time, data from the grid indicating that the grid is operating on the use of renewable energies such as solar or wind power. Model system 260 can be trained to recognize the use of renewable energies and can be trained elect to use more power than when the grid is operating on nonrenewable energies. In some embodiments, the building and model system 260 can also be assigned a sustainability score. In some embodiments, building utilities can be monetized. In some embodiments, real-time pricing of utility, power grid usage, and demand variables can be determined and used as inputs to model system 260.

Model system 260 can have external information as training inputs. For example, information on environmental factors, such as weather, or building events can be input into model system 260. The information as an input can be related to an event happening in the future, so there is a delay between model system 260 receiving the input and executing the process. Model system 260 can instruct system 200 to pre-condition a space in response to the input in order to reduce the need of system 200 (i.e., HVAC). For example, if an input to model system 260 is that the weather for the following day will start cool and temperatures will rise throughout the day, model system 260 can be previously trained to output a thermostat setting will be set for one temperature in the morning and incrementally change throughout the course of the day. As another example, if there is a large drop in outdoor temperature between two consecutive days, model system 260 can use the weather forecast as an input so that system 200 does not deliver as cool of temperatures the second day, in order to reduce the load. In some embodiments, model system 260 can pre-charge on-site energy storage to meet the needs of the building based on inputs to model system 260. Additional variables beyond indoor temperature, including but not limited to outdoor temperature, humidity and outdoor air quality, can also be input to model system 260 as elements that affect user tolerance and comfort. For example, the outdoor air temperature dictates what users wear, which can affect the tolerance model trained by model system 260. In some embodiments, model system 260 learns differently based on inputs that vary according to the season. For example, model system 260 can identify cyclic patterns in user inputs that relate to seasonal differences in user tolerances. In some embodiments, model system 260 learns differently based on inputs that vary with the time of day. For example, the model system 260 can be trained to modulate the amount or brightness of lighting in the space based on inputs relating to the angle of the sun during different times of the day. In some embodiments, model system 260 can be trained to recognize features of the space and determine how to adjust accordingly. For example, model system 260 can be trained to recognize when the blinds in an office are open versus closed, or when the door to an office is open versus closed, which can affect model system 260 outputs.

In some embodiments, model system 260 uses occupancy sensing to determine tolerances. Model system 260 can be trained to determine how many occupants are in a space at one time and adjust accordingly. For example, model system 260 can be trained to set a lower temperature in a space in which a large meeting with many participants is occurring. In some embodiments, the model system 260 can be trained to learn that its performance only needs to rely on user tolerances when the space in which model system 260 is operating is occupied by users. In some embodiments, model system 260 can receive inputs such as scheduling information relevant to the space in which it is operating to retrain the model and adjust the outputs. Model system 260 can use individual user schedules as inputs, such as when system 200 is used in a single office. Model system 260 can also use multiple schedules as inputs, such as when system 200 is used in a cubicle grouping.

### Occupant Response-Based Sustainability Embodiments

Still referring to FIG. 2, the system 200 and/or model 104 of FIG. 1 can perform operations for building management, utilizing AI to process input data, configure machine learning models, and analyze occupant responses to incremental changes in environmental conditions, in some embodiments. For example, model system 260 and/or model 104 of FIG. 1 can perform method 900, where at time t1, system 200 updates a building condition such as an HVAC setpoint, and at time t2, the system performs further incremental adjustments. In another example, system 200 can use occupant responses received at t3 via a control device (e.g., thermostat) to dynamically adjust the temperature within a space. In some embodiments, model system 260 can log each response to refine tolerance thresholds by testing comfort levels across a series of incremental adjustments to temperature or lighting, and at each and/or at least one stage, data entries can be created corresponding to changes made by the occupant. For example, a reduction of lighting by 10 lux per day can continue until system 200 detects a specific response, such as an increase in lighting through a control device. In another example, if the temperature is raised incrementally, the system 200 can record each response where an occupant changes the thermostat, establishing tolerance boundaries that system 200 can later retrieve and apply to various zones within the building.

In some embodiments, the data repository 204 of system 200 can store various occupant responses and building condition logs, which serve as a source of training data for model system 260. For example, operations database 216 can include occupant-specific tolerance data, such as records of lighting levels or HVAC setpoint adjustments. In one example, system 200 can adjust lighting levels daily by a set increment, such as 10 lux, until occupants provide feedback (e.g., adjusting lighting levels via control devices), signaling that a tolerance threshold has been reached. System 200 stores this feedback as data entries within operations database 216, labeling each entry with the specific tolerance conditions. In another example, if an occupant manually changes a thermostat setpoint multiple times during high outdoor temperatures, model system 260 can analyze this data to identify a tolerance range of an occupant for that temperature, which can then be applied during future temperature management processes. In some embodiments, the data repository 204 can also aggregate tolerance data across different zones or spaces within the building to analyze patterns of response, allowing system 200 to create consolidated sets of tolerance limits for spaces shared by multiple occupants.

The prompt management system 228 within system 200 can generate prompts and completions for training model system 260 based on real-time occupant responses. For example, prompt management system 228 can retrieve occupant response data from data repository 204 to construct prompts that correspond to specific building condition changes, such as incremental reductions in temperature or lighting levels. In some embodiments, at least one (e.g., each) prompt generated can include occupant responses as completions, which can be stored in the prompts database 224 to be retrieved during model training. For example, a generated prompt can detail a temperature increase of two degrees within a particular space, with a response of an occupant to this change logged as a completion (e.g., setting the thermostat back to the original temperature). In another example, system 200 can generate a prompt associated with a reduction in airflow, and the completion can consist of an adjustment or feedback received through the HVAC control interface. In some embodiments, the prompts and completions can be applied by model system 260 during training to improve tolerance mapping across individual spaces, with at least one (e.g., each) prompt detailing a specific environmental change and the completion recording occupant adjustments made in response.

The training management system 240 in system 200 can use training manager 244 to organize and control the application of data elements generated by prompt management system 228, directing them to model system 260 to adjust tolerance predictions. For example, training manager 244 can retrieve data from prompts database 224 and/or from prompts dataset 248 to schedule and execute training operations (e.g., fine-tuning model parameters, adapting learning rates, processing occupant feedback integration) on model system 260, providing structured data to facilitate training on occupant tolerance levels. In some embodiments, the training manager 244 can access parameters stored in the model tuning database 256, adjusting settings such as temperature or lighting increments, depending on occupant response data. In one example, training manager 244 can use data from operations database 216 detailing occupant adjustments to lighting over multiple time periods to determine a preferred lighting range, then refine this range with hyperparameters (e.g., historical response rates, seasonal occupancy patterns, environmental conditions) such as occupant density in a shared space. In another example, data collected regarding the frequency and degree of manual thermostat adjustments can inform model system 260 on a specific temperature range for the space.

Model system 260 in system 200 includes a model configuration processor 264, which configures machine learning models 268 with training data received from training manager 244. In some embodiments, model configuration processor 264 can apply occupant interaction data (e.g., manual thermostat adjustments, mobile app feedback entries, recorded lighting changes, air quality preferences, and/or any temperature-related preferences) stored in prompts dataset 248, facilitating the establishment of occupant tolerance ranges of model system 260 by continuously updating model parameters. For example, model configuration processor 264 can identify occupant responses to HVAC adjustments, processing these as data points to update the setpoint tolerance range for temperature of the occupant. In another example, model configuration processor 264 processes interactions related to lighting adjustments in high-occupancy areas (e.g., open workspaces, conference rooms, common areas), establishing a tolerance baseline based on the cumulative response data. Additionally, model configuration processor 264 can access model tuning database 256 for parameters that correlate occupant comfort levels with environmental conditions, implementing model adjustments that differentiate tolerance settings across spaces. For example, processor 264 can retrieve parameters corresponding to seasonal variations in occupant comfort, further refining tolerance predictions based on these periodic influences.

The feedback repository 124 within system 200 stores occupant response data that model system 260 uses to refine tolerance levels. For example, each occupant interaction, such as adjusting temperature or reporting discomfort, is logged in feedback repository 124, providing model system 260 with historical data that indicates specific tolerance thresholds. In some embodiments, system 200 can retrieve feedback entries in response to specific HVAC changes and apply them to calculate adjustments in temperature setpoints for individual spaces. In one example, data reflecting an increase of airflow in response to a drop in outdoor temperature can be retrieved by model system 260 to assess a baseline for air quality preferences. In another example, model system 260 can process multiple instances where occupants in shared spaces reduce lighting levels at certain times of day, creating a summary tolerance range that can guide future lighting settings. The feedback repository 124 can be used to refine occupant preferences across different building zones by referencing logged adjustments made during prior environmental changes.

Generative AI models within model system 260 can facilitate the generation of occupant-specific prompts by system 200 during times when environmental settings exceed identified tolerance levels. For example, if the HVAC temperature rises beyond an established range of an occupant, model system 260 generates a prompt that is delivered to the occupant, which can include a message asking if the occupant agrees to a temporary adjustment for sustainability purposes. For example, system 200 can issue a prompt that asks an occupant to confirm their comfort level with a temporary lighting reduction, to which the response of the occupant can then be logged as further training data. Another example includes system 200 generating prompts to occupants in response to air quality levels, asking if adjustments are necessary, based on system data indicating prior occupant preferences for specific air quality ranges. System 200 can collect each response as an input to refine tolerance mapping.

In some embodiments, occupancy sensing within system 200 can provide real-time data to model system 260, facilitating the adjustments of environmental conditions based on actual space utilization. For example, occupancy sensors (e.g., infrared motion sensors, ultrasonic sensors, camera-based sensors, and/or thermal imaging sensors) can detect variations in the number of individuals within a space, triggering model system 260 to adjust airflow based on occupancy levels. In some embodiments, system 200 can identify an increase in occupant density within a conference room, prompting model system 260 to lower the temperature setpoint in response. Another example includes system 200 detecting a reduction in occupancy in a workspace and subsequently reducing HVAC output to save energy. In some embodiments, at least one (e.g., each) change recorded by occupancy sensing devices can be stored in data repository 204 as context for future training cycles, allowing model system 260 to analyze patterns of occupancy-related adjustments, which can then be retrieved and applied by system 200 during real-time operations across different building zones.

In some embodiments, environmental data from external sources, such as weather and grid data, can be fed into system 200 and applied by model system 260 to adjust building conditions during high-demand periods (e.g., extreme weather forecasts, power grid strain alerts, peak electricity usage warnings). For example, model system 260 can use projected high outdoor temperatures to initiate preconditioning adjustments in HVAC systems, setting lower temperatures in the morning to avoid peak usage later in the day. In another example, grid data (e.g., obtaining by communication with utility provider APIs or smart grid APIs) indicating a scheduled demand response event can trigger system 200 to pre-charge energy storage devices or initiate gradual temperature increases. That is, the environmental inputs can be stored in data repository 204, where model system 260 retrieves them to determine occupancy-sensitive temperature settings that reduce energy costs. System 200 can also use grid data to schedule demand response actions across multiple zones, calculating specific adjustments per zone based on occupant density and energy usage patterns detected in prior model training.

In some embodiments, training management system 240 can retrieve occupancy patterns from data repository 204 and apply the patterns to configure the HVAC setpoints and airflow rates for specific zones, adjusting these settings at predetermined times of day (e.g., peak hours, off-peak hours, seasonal shifts). In various embodiments, model system 260 can manage adjustments in spaces that exhibit varied occupancy schedules (e.g., shared workspaces, private offices, collaborative zones), updating the humidity and air quality levels in accordance with real-time occupancy data. Prompt management system 228 can retrieve schedule data (e.g., recurring meeting times, reserved conference room slots, shift changes) from the data repository 204 to improve HVAC schedules, configuring the temperature and ventilation parameters in areas anticipating increased occupancy. By using the operations database 216 to log these changes, system 200 can establish a record of adjusted parameters to inform future configurations based on occupancy trends.

The model system 260, within system 200, can implement a generative large language model (LLM) (e.g., a pretrained generative transformer model, autoregressive model, bidirectional encoder model, and/or any neural network language model) to interpret occupant responses provided through control devices. For example, the LLM (e.g., model 104) can process natural language feedback submitted by occupants via mobile applications connected to prompt management system 228, converting this feedback into structured commands for training management system 240. In this example, if an occupant provides input requesting a specific lighting adjustment, the LLM can interpret the language to identify specific lux levels and direct model system 260 to modify the lighting settings accordingly. In some embodiments, model system 260 can also analyze historical feedback stored in the feedback repository 124 to generate occupant prompts.

The data repository 204 within system 200 can store specific building conditions across multiple spaces, including, but not limited to, temperature setpoints, lighting levels, air quality metrics, ventilation rates, humidity levels, and outdoor air fractions, which model system 260 can adjust based on occupant responses. For example, operations database 216 can store tolerance data that model system 260 retrieves to incrementally adjust lighting levels, initiating reductions in 10-lux increments until occupants respond with adjustments through thermostats or mobile applications. Additionally, training management system 240 can analyze changes in temperature setpoints based on occupancy density within data repository 204, identifying preferred thresholds for various spaces (e.g., individual offices, conference rooms, shared work areas, manufacturing floors, sport arena, hotel room, airport security area). In some embodiments, the model configuration processor 264 can adjust parameters for ventilation rates, modifying airflow in response to feedback regarding air quality. That is, model system 260 can process data points to refine the operating conditions of HVAC components within system 200 based on observed occupant tolerance.

In some embodiments, the data repository 204 can also log occupant response data received from various control devices, including thermostats (e.g., mounted in the space), mobile applications, wall-mounted control panels, occupancy sensors, and/or any wearable sensors providing system 200 with feedback to adjust building conditions. For example, thermostat adjustments recorded in the operations database 216 can facilitate training management system 240 to refine tolerance data for at least one (e.g., each) space, directing model system 260 to apply changes based on real-time occupant input. In some embodiments, occupant feedback submitted through mobile applications can be processed by the prompt management system 228, which can categorize responses to lighting and air quality conditions (or other environmental parameters) for storage in feedback repository 124. Model system 260 can retrieve the tolerance indicators from the data repository 204, applying each input as a distinct training data point for temperature, lighting, ventilation, humidity, airflow, and/or outdoor air fraction settings. That is, the data collection process facilitates the application of occupant-specific adjustments across different environmental controls by system 200 and/or model 104.

In some embodiments, prompt management system 228 of system 200 can generate prompts in response to occupant adjustments, providing options to confirm or alter HVAC settings in line with occupant feedback. For example, if an occupant changes a thermostat setting due to temperature discomfort, prompt management system 228 can generate a prompt on the mobile application asking the occupant to confirm the adjustment or accept a temporary increase. This prompt, once confirmed, can be stored in feedback repository 124, where model system 260 retrieves the response to apply as a tolerance data point for future HVAC configurations. In another example, the prompt management system 228 can detect lighting reduction adjustments made on wall-mounted controls, subsequently generating a follow-up prompt to validate the comfort level of the occupant. Model system 260 can process each confirmation or adjustment stored in data repository 204 as feedback, refining the model parameters for HVAC conditions based on consistent occupant interaction.

The model system 260 can provide and/or otherwise present prompts via a generative AI model on a mobile device (e.g., client device 304), presenting occupants with suggestions to reduce building load, offering alternative comfort settings, energy-saving tips, and/or any carbon-reducing actions in response to peak demand periods, such as during extreme temperatures, power grid strain, and/or any high-consumption times. For example, during high energy demand, prompt management system 228 can notify occupants via a mobile application with a suggestion to raise the temperature slightly, storing each response of the occupant in feedback repository 124 as a tolerance input. In another example, model system 260 can issue prompts recommending adjustments to ventilation rates in unoccupied spaces, guiding occupants to confirm or adjust the prompt based on comfort or desire to reduce their carbon footprint. In some embodiments, training management system 240 can retrieve occupant responses to the load-reduction recommendations, applying them in model system 260 as training data for future demand events. In some embodiments, system 200 can configure the load-shedding measures across HVAC systems based on preferred levels of one or more occupants.

In some embodiments, model system 260 can also process unstructured data corresponding to occupant feedback associated with various building conditions, using the data to train AI models (e.g., model(s) 268 and/or model 104) for more accurate control of HVAC components. For example, if an occupant submits feedback indicating discomfort through a mobile application, model system 260 can retrieve the unstructured input and tokenize the data in prompt management system 228 to apply it in future temperature adjustments. Additionally, feedback received as freeform text via wall-mounted control devices can be classified in data repository 204. That is, the training management system 240 can apply this data to train the AI model on specific occupant preferences across lighting, airflow, temperature, and/or any other environmental factors.

The model system 260 can manage and aggregate a plurality of tolerance responses for various occupants within system 200. That is, the tolerance responses can be applied to the AI model to adjust specific setpoints in different spaces. For example, operations database 216 can log multiple occupant responses to recent temperature adjustments in shared office areas, identifying average tolerance thresholds that training management system 240 retrieves to establish HVAC conditions. In another example, feedback repository 124 can store individual responses to lighting adjustments across different zones, which model configuration processor 264 can use to identify suitable lighting levels based on cumulative occupant input. In some embodiments, the model system 260 can process the tolerance responses to facilitate the application of individual and group preferences for different environmental controls across building spaces.

In some embodiments, the system 200 can generate actions for the HVAC system in response to receiving occupant feedback. That is, the generated actions can align the adjustments of the occupant with each tolerance level for building conditions. For example, if feedback repository 124 logs occupant discomfort due to high temperatures, training management system 240 can initiate a command (e.g., reduce temperature setpoint, increase airflow, activate cooling mode) within model system 260 to lower the temperature in response to the tolerance threshold stored for that zone. In another example, if data repository 204 stores feedback indicating that lighting levels are set too high, model system 260 can generate an action that reduces the lighting level to an established tolerance limit. In some embodiments, at least one (e.g., each) action generated can correspond with occupant feedback.

In some embodiments, model system 260 can independently manage building conditions for multiple spaces by updating HVAC parameters in separate zones. That is, at least one (e.g., each) space can be configured according to specific occupant responses. For example, operations database 216 can store temperature adjustments applied in a single office at time t4, which training management system 240 uses to update lighting or air quality metrics for a different office at time t5. Model configuration processor 264 can retrieve this data for each space independently, allowing system 200 to adjust conditions based on occupant-specific preferences across individual zones. In some embodiments, in shared spaces, model system 260 can use responses stored in data repository 204 to refine tolerance levels separately for at least one (e.g., each) occupant group.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268. While various embodiments are described as being implemented using generative AI models such as transformers and/or GANs, in some embodiments, various features described herein can be implemented using non-generative AI models or even without using AI/machine learning, and all such modifications fall within the scope of the present disclosure.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some embodiments, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some embodiments, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which can include at least one of the first prompt or the first completion concatenated to the second prompt), and provide the second completion to the application session 308.

In some embodiments, the application session 308 maintains a session state regarding the application session 308. The session state can include one or more prompts received by the application session 308, and can include one or more completions received by the application session 308 from the model system 260. The session state can include one or more items of feedback received regarding the completions, such as feedback indicating accuracy of the completion.

The system 200 can include or be coupled with one or more session inputs 340 or sources thereof. The session inputs 340 can include, for example and without limitation, location-related inputs, such as identifiers of an entity managing an item of equipment or a building or building management system, a jurisdiction (e.g., city, state, country, etc.), a language, or a policy or configuration associated with operation of the item of equipment, building, or building management system. The session inputs 340 can indicate an identifier of the user of the application session 308. The session inputs 340 can include data regarding items of equipment or building management systems, including but not limited to operation data or sensor data. The session inputs 340 can include information from one or more applications, algorithms, simulations, neural networks, machine learning models, or various combinations thereof, such as to provide analyses, predictions, or other information regarding items of equipment. The session inputs 340 can data from or analogous to the data of the data repository 204.

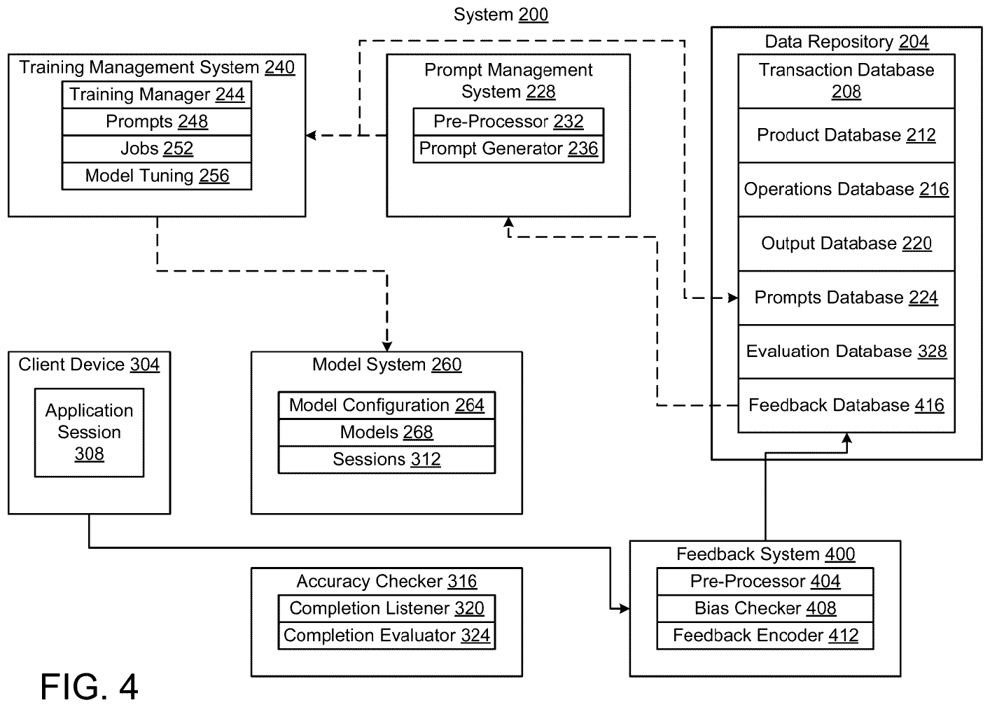

In some embodiments, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268. The sessions database 312 can include one or more session states of the application session 308.

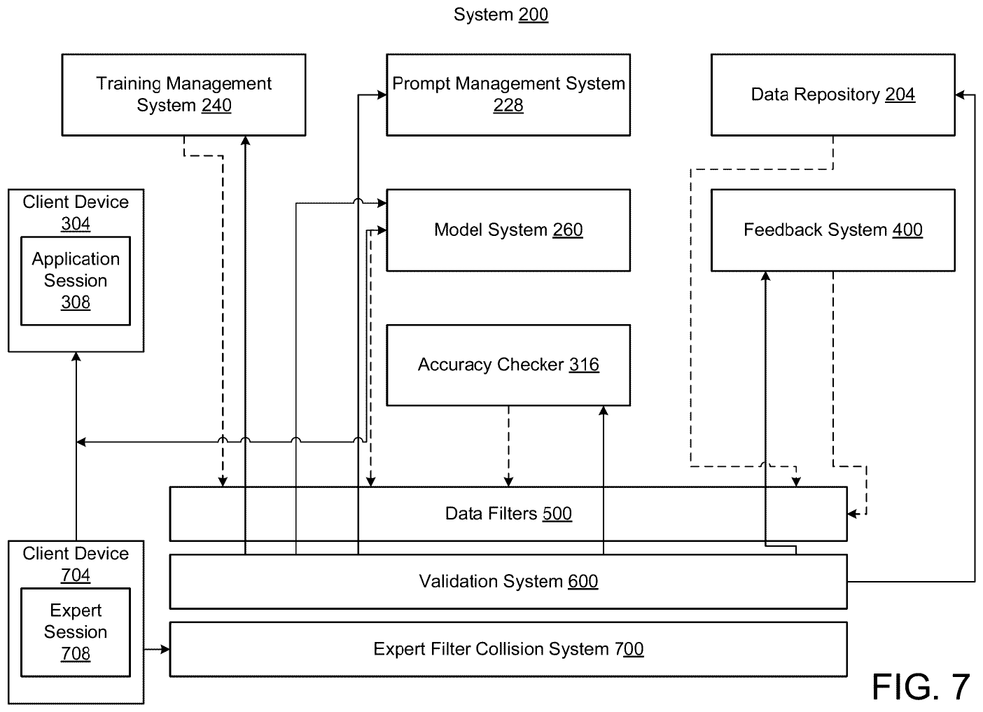

As depicted in FIG. 3, the system 200 can include at least on pre-processor 332. The pre-processor 332 can evaluate the prompt according to one or more criteria and pass the prompt to the model system 260 responsive to the prompt satisfying the one or more criteria, or modify or flag the prompt responsive to the prompt not satisfying the one or more criteria. The pre-processor 332 can compare the prompt with any of various predetermined prompts, thresholds, outputs of algorithms or simulations, or various combinations thereof to evaluate the prompt. The pre-processor 332 can provide the prompt to an expert system (e.g., expert system 700 described with reference to FIG. 7) for evaluation. The pre-processor 332 (and/or post-processor 336 described below) can be made separate from the application session 308 and/or model system 260, which can modularize overall operation of the system 200 to facilitate regression testing or otherwise employ more effective software engineering processes for debugging or otherwise improving operation of the system 200. The pre-processor 332 can evaluate the prompt according to values (e.g., numerical or semantic/text values) or thresholds for values to filter out of domain inputs, such as inputs targeted for jail-breaking the system 200 or components thereof, or filter out values that do not match target semantic concepts for the system 200.

### Completion Checking

In some embodiments, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 260 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some embodiments, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some embodiments, the accuracy checker 316 can store an output from evaluating the completion (e.g., an indication of whether the completion satisfies the criteria) in an evaluation database 328. For example, the accuracy checker 316 can assign the output (which can indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

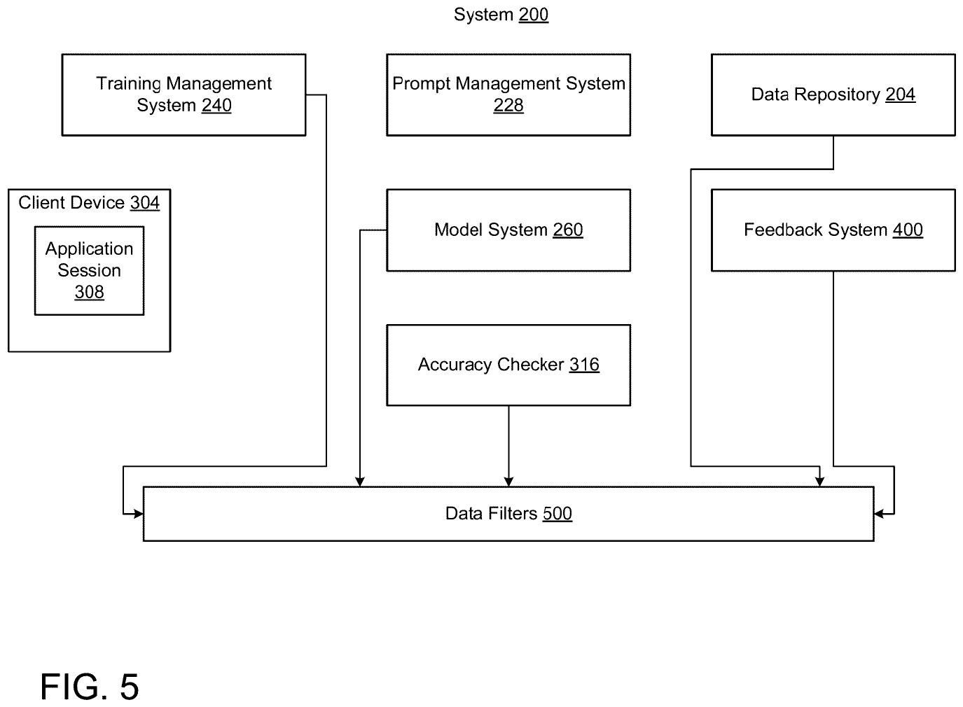

The accuracy checker 316 can include or be coupled with at least one post-processor 336. The post-processor 336 can perform various operations to evaluate, validate, and/or modify the completions generated by the model system 260. In some embodiments, the post-processor 336 includes or is coupled with data filters 500, validation system 600, and/or expert system 700 described with reference to FIGS. 5-7. The post-processor 336 can operate with one or more of the accuracy checker 316, external systems 344, operations data 348, and/or role models 360 to query databases, knowledge bases, or run simulations that are granular, reliable, and/or transparent.

Referring further to FIG. 3, the system 200 can include or be coupled with one or more external systems 344. The external systems 344 can include any of various data sources, algorithms, machine learning models, simulations, internet data sources, or various combinations thereof. The external systems 344 can be queried by the system 200 (e.g., by the model system 260) or the pre-processor 332 and/or post-processor 336, such as to identify thresholds or other baseline or predetermined values or semantic data to use for validating inputs to and/or outputs from the model system 260. The external systems 344 can include, for example and without limitation, documentation sources associated with an entity that manages items of equipment.

The system 200 can include or be coupled with operations data 348. The operations data 348 can be part of or analogous to one or more data sources of the data repository 204. The operations data 348 can include, for example and without limitation, data regarding real-world operations of building management systems and/or items of equipment, such as changes in building policies, building states, tolerance changes, threshold determinations, ticket or repair data, results of servicing or other operations, performance indices, or various combinations thereof. The operations data 348 can be retrieved by the application session 308, such as to condition or modify prompts and/or requests for prompts on operations data 348.

### Role-Specific Machine Learning Models

As depicted in FIG. 3, in some embodiments, the models 268 can include or otherwise be implemented as one or more role-specific models 360. The models 360 can be configured using training data (and/or have tuned hyperparameters) representative of particular tasks associated with generating accurate completions for the application sessions 308 such as to perform iterative communication of various language model job roles to refine results internally to the model system 260 (e.g., before/after communicating inputs/outputs with the application session 308), such as to validate completions and/or check confidence levels associated with completions. By incorporating distinct models 360 (e.g., portions of neural networks and/or distinct neural networks) configured according to various roles, the models 360 can more effectively generate outputs to satisfy various objectives/key results.

For example, the role-specific models 360 can include one or more of an author model 360, an editor model 360, a validator model 360, or various combinations thereof. The author model 360 can be used to generate an initial or candidate completion, such as to receive the prompt (e.g., via pre-processor 332) and generate the initial completion responsive to the prompt. The editor model 360 and/or validator model 360 can apply any of various criteria, such as accuracy checking criteria, to the initial completion, to validate or modify (e.g., revise) the initial completion. For example, the editor model 360 and/or validator model 360 can be coupled with the external systems 344 to query the external systems 344 using the initial completion (e.g., to detect a difference between the initial completion and one or more expected values or ranges of values for the initial completion), and at least one of output an alert or modify the initial completion (e.g., directly or by identifying at least a portion of the initial completion for the author model 360 to regenerate). In some embodiments, at least one of the editor model 360 or the validator model 360 are tuned with different hyperparameters from the author model 360, or can adjust the hyperparameter(s) of the author model 360, such as to facilitate modifying the initial completion using a model having a higher threshold for confidence of outputted results responsive to the at least one of the editor model 360 or the validator model 360 determining that the initial completion does not satisfy one or more criteria. In some embodiments, the at least one of the editor model 360 or the validator model 360 is tuned to have a different (e.g., lower) risk threshold than the author model 360, which can allow the author model 360 to generate completions that can fall into a greater domain/range of possible values, while the at least one of the editor model 360 or the validator model 360 can refine the completions (e.g., limit refinement to specific portions that do not meet the thresholds) generated by the author model 360 to fall within appropriate thresholds (e.g., rather than limiting the threshold for the author model 360).

For example, responsive to the validator model 360 determining that the initial completion includes a value (e.g., setpoint to meet a target value of a performance index) that is outside of a range of values validated by a simulation for an item of equipment, the validator model 360 can cause the author model 360 to regenerate at least a portion of the initial completion that includes the value; such regeneration can include increasing a confidence threshold for the author model 360. The validator model 360 can query the author model 360 for a confidence level associated with the initial completion, and cause the author model 360 to regenerate the initial completion and/or generate additional completions responsive to the confidence level not satisfying a threshold. The validator model 360 can query the author model 360 regarding portions (e.g., granular portions) of the initial completion, such as to request the author model 360 to divide the initial completion into portions, and separately evaluate each of the portions. The validator model 360 can convert the initial completion into a vector, and use the vector as a key to perform a vector concept lookup to evaluate the initial completion against one or more results retrieved using the key.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1. While various embodiments are described as being implemented using generative AI models such as transformers and/or GANs, in some embodiments, various features described herein can be implemented using non-generative AI models or even without using AI/machine learning, and all such modifications fall within the scope of the present disclosure.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some embodiments, the feedback system 400 includes a pre-processor. The pre-processor can perform any of various operations to modify the feedback for further processing. For example, the pre-processor can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some embodiments, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

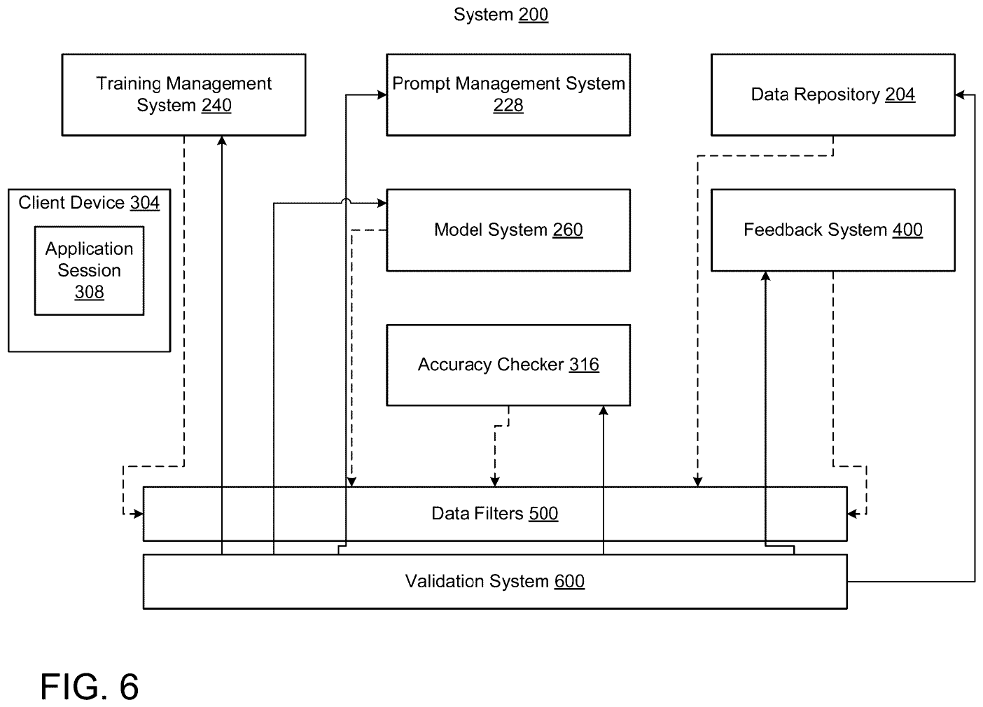

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can allow the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can allow the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some embodiments, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some embodiments, the system 200 selectively requests feedback indicative of thresholds based on an identifier of a user of the application session 308, such as to selectively request feedback from users having predetermined levels of expertise and/or assign weights to feedback according to criteria such as levels of expertise.

In some embodiments, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some embodiments, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some embodiments, the system 200 can pass data to a destination without modifying the data (e.g., retaining a value of the data prior to evaluation by the data filter 500) responsive to the data satisfying the criteria of the respective data filter(s) 500. In some embodiments, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some embodiments, the system 200 modifies the data by causing the machine learning models 268 to regenerate the completion corresponding to the data (e.g., for up to a predetermined threshold number of regeneration attempts before triggering the alert). This can allow the data filters 500 and the system 200 selectively trigger alerts responsive to determining that the data (e.g., the collision between the data and the thresholds of the data filters 500) cannot be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some embodiments, the validation system 600 receives a given item of data prior to the given item of data being processed by the model system 260, such as to validate inputs to the machine learning models 268 prior to the inputs being processed by the machine learning models 268 to generate outputs, such as completions.

In some embodiments, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can allow the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some embodiments, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some embodiments, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can allow the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that can be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert system 700 can facilitate functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some embodiments, the expert system 700 can use feedback received via the expert session as inputs to update the machine learning models 268 (e.g., to perform fine-tuning).

In some embodiments, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some embodiments, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 700 to selectively identify experts to use for monitoring and validating the data.

In some embodiments, the expert system 700 facilitates a communication session regarding the data, between the application session 308 and the expert session 708. For example, the expert session 708, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some embodiments, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some embodiments, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some embodiments, the data repository 204 maintains building data platform-specific databases, such as to allow the system 200 to configure the machine learning models 268 on a building data platform-specific basis (or on an entity-specific basis using data from one or more building data platforms maintained by the entity).

For example, in some embodiments, various data discussed herein can be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In various embodiments, first models can be logically and/or physically distributed, interact, and/or be orchestrated by a second model to achieve the targeted outcome(s). In various embodiments, the first models are central. In some such embodiments, the building data platforms and/or digital twins can be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application number 202341008712, filed Feb. 10, 2023, the disclosures of which are incorporated herein by reference in their entireties. While various embodiments are described as being implemented using generative AI models such as transformers and/or GANs, in some embodiments, various features described herein can be implemented using non-generative AI models or even without using AI/machine learning, and all such modifications fall within the scope of the present disclosure.

### III. Generative AI-Based Systems and Methods for Learning and Utilizing Occupant Tolerance in Demand Response

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance. While various embodiments are described as being implemented using generative AI models such as transformers and/or GANs, in some embodiments, various features described herein can be implemented using non-generative AI models (i.e., general AI models) or even without using AI/machine learning, and all such modifications fall within the scope of the present disclosure.

### Implementing GAI Architectures for Building Management Systems

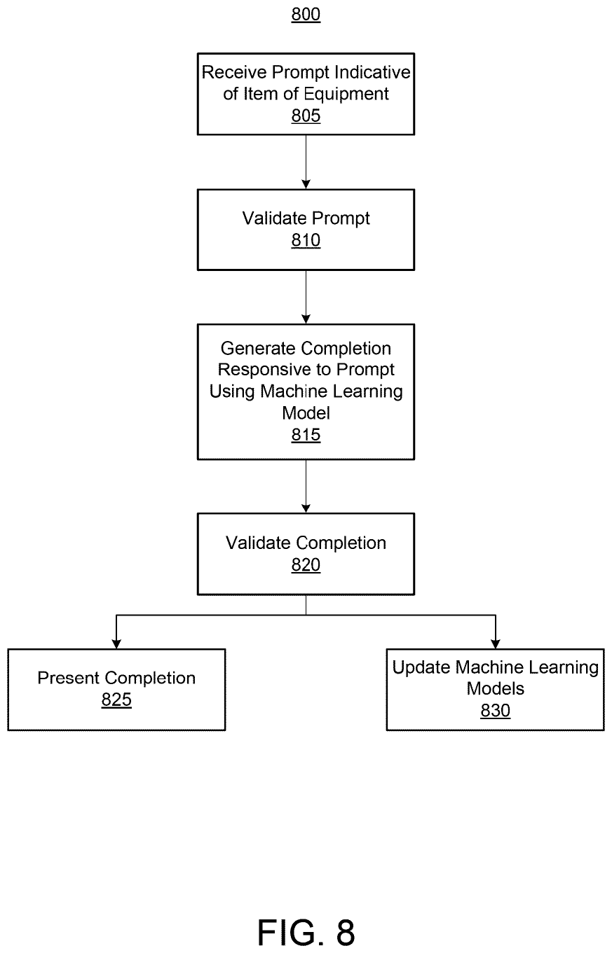

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures. As described with respect to various aspects of the system 200 (e.g., with reference to FIGS. 3-7), the method 800 can implement operations to facilitate more accurate, precise, and/or timely determination of completions to prompts from users regarding items of equipment, such as to incorporate various validation systems to improve accuracy from generative models.

At 805, a prompt can be received. The prompt can be received using a user interface implemented by an application session of a user device or HVAC operating parameter, such as a smart thermostat. The prompt can be received in any of various data formats, such as text, audio, speech, image, and/or video formats. The prompt can be indicative of a user action responsive to a setpoint modulation, such as increasing the temperature on a thermostat. The prompt can indicate a request for a change in the setpoint or a user tolerance level. In some embodiments, the application session provides a conversational interface or chatbot for receiving the prompt, and can present queries via the application to request information for the prompt. For example, the application session can determine that the prompt indicates a type of HVAC operating parameter, such as air temperature, and can request information regarding preferences of the user in reference to that operating parameter of the HVAC system (e.g., via iterative generation of completions and communication with machine learning models).

At 810, the prompt is validated. For example, criteria such as one or more rules, heuristics, models, algorithms, thresholds, policies, or various combinations thereof can be evaluated using the prompt. The criteria can be evaluated to determine whether the prompt is appropriate for the item of equipment. In some embodiments, the prompt can be evaluated by a pre-processor that can be separate from at least one of the application session or the machine learning models. In some embodiments, the prompt can be evaluated using any one or more accuracy checkers, data filters, simulations regarding operation of the item of equipment, or expert validation systems; the evaluation can be used to update the criteria (e.g., responsive to an expert determining that the prompt is valid even if the prompt includes information that does not satisfy the criteria, the criteria can be updated to be capable of being satisfied by the information of the prompt). In some embodiments, the prompt is modified according to the evaluation; for example, a request can be presented via the application session for an updated version of the prompt, or the pre-processor can modify the prompt to make the prompt satisfy the one or more criteria. The prompt can be converted into a vector to perform a lookup in a vector database of expected prompts or information of prompts to validate the prompt.

At 815, at least one completion is generated using the prompt (e.g., responsive to validating the prompt). The completion can be generated using one or more machine learning models, including generative machine learning models. For example, the completion can be generated using a neural network comprising at least one transformer, such as GPT model. The completion can be generated using image/video generation models, such as GAN and/or diffusion models. The completion can be generated based on the one or more machine learning models being configured (e.g., trained, updated, fine-tuned, etc.) using training data examples representative of information for items of equipment, including but not limited to unstructured data or semi-structured data such as user preferences, setpoint modulations, etc. Prompts can be iteratively received and completions iteratively generated responsive to the prompts as part of an asynchronous and/or conversational communication session.

In some embodiments, generating the prompt comprises using a plurality of machine learning models, which can be configured in similar or different manners, such as by using different training data, model architectures, parameter tuning or hyperparameter fine tuning, or various combinations thereof. In some embodiments, the machine learning models are configured in a manner representative of various roles, such as author, editor, validation, external data comparison, etc. roles. For example, a first machine learning model can operate as an author model, such as to have relatively fewer/lesser criteria for generating an initial completion responsive to the prompt, such as to require relatively lower confidence levels or risk criteria. A second machine learning model can be configured to have relatively greater/higher criteria, such as to receive the initial completion, process the initial completion to detect one or more data elements (e.g., tokens or combinations of tokens) that do not satisfy criteria of the second machine learning model, and output an alert or cause the first machine learning model to modify the initial completion responsive to the valuation. For example, the editor model can identify a phrase in the initial completion that does not satisfy an expected value (e.g., expected accuracy criteria determined by evaluating the prompt using a simulation), and can cause the first machine learning model to provide a natural language explanation of factors according to which the initial completion was determined, such as to present such explanations via the application session. The machine learning models can evaluate the completions according to bias criteria. The machine learning models can store the completions and prompts as data elements for further configuration of the machine learning models (e.g., positive/negative examples corresponding to the prompts).

At 820, the completion can be validated. The completion can be validated using various processes described for the machine learning models, such as by comparing the completion to any of various thresholds or outputs of databases or simulations. For example, the machine learning models can configure calls to databases or simulations for the item of equipment indicated by the prompt to validate the completion relative to outputs retrieved from the databases or simulations. The completion can be validated using accuracy checkers, bias checkers, data filters, or expert systems.

At 825, the completion is presented via the application session. For example, the completion can be presented as any of text, speech, audio, image, and/or video data to represent the completion, such as to provide an answer to a query represented by the prompt regarding an item of equipment or building management system. The completion can be presented via iterative generation of completions responsive to iterative receipt of prompts. The completion can be present with a user input element indicative of a request for feedback regarding the completion, such as to allow the prompt and completion to be used for updating the machine learning models.

At 830, the machine learning model(s) used to generate the completion can be updated according to at least one of the prompt, the completion, or the feedback. For example, a training data element for updating the model can include the prompt, the completion, and the feedback, such as to represent whether the completion appropriately satisfied a user's request for information regarding the item of equipment. The machine learning models can be updated according to indications of accuracy determined by operations of the system such as accuracy checking, or responsive to evaluation of completions by experts (e.g., responsive to selective presentation and/or batch presentation of prompts and completions to experts).

### Implementing Sustainability AI Architectures for Building Management Systems

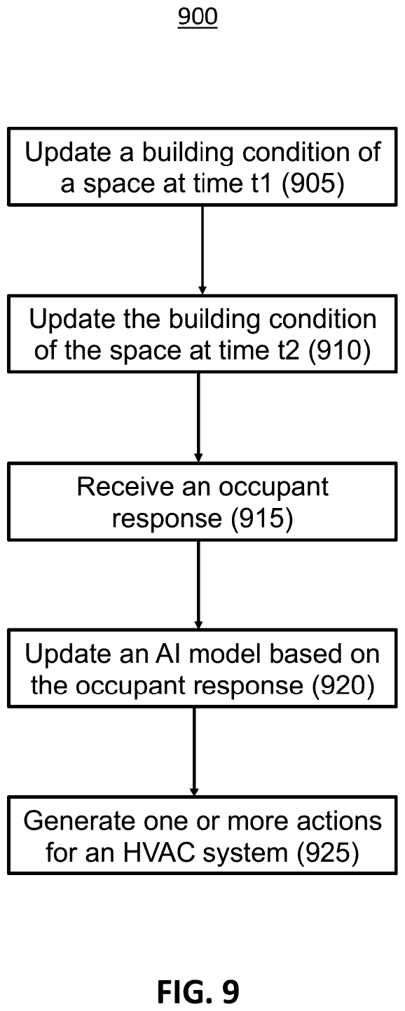

Referring now to FIG. 9, a flowchart for a method 900 is shown, according to some embodiments. Model 104, model system 260, and/or system 200 can be configured to perform method 900. Further, any computing device described herein can be configured to perform method 900.

In broad overview of method 900, at block 905, the one or more processing circuits can update a building condition of a space at time t1. At block 910, the one or more processing circuits can update the building of the space at time t2. At block 915, the one or more processing circuits can receive an occupant response. At block 920, the one or more processing circuits can update an AI model based on the occupant response. At block 925, the one or more processing circuits can generate one or more actions for an HVAC system. Additional, fewer, or different operations can be performed depending on the particular arrangement. In some embodiments, some, or all operations of method 900 can be performed by one or more processing circuits executing on one or more computing devices, systems, or servers. In various embodiments, each operation can be re-ordered, added, removed, or repeated.

In some embodiments, an artificial intelligence/machine learning (AI/ML) is employed to stress test the potential load reduction from a building based on an occupancy response. At block 905, the one or more processing circuits can update a building condition of an HVAC system of a space in a building at a time t1. That is, the building condition can be updated from a default building condition. For example, a default building condition can be an initial temperature setpoint of 72 degrees Fahrenheit with standard ventilation and lighting levels appropriate for typical occupancy. Time t1 can be set to an early occupancy period, such that adjustments begin as occupants start entering the space. At block 910, the one or more processing circuits can update the building condition of the HVAC system of the space in the building at a time t2. In some embodiments, the building condition can include at least one of a temperature setpoint of the space, a level of lighting in the space, an air quality metric of the space, ventilation of the space, a humidity setpoint of the space, an outdoor air fraction of the space. For example, the processing circuits can update the building condition by lowering the temperature setpoint by two degrees or reducing lighting by 10 lux in response to occupancy feedback. In this example, time t1 can be set to 9:00 a.m., and time t2 can be set to 10:00 a.m., such that the processing circuits can implement incremental adjustments based on observed occupant comfort levels.

At blocks 915 and 920, the one or more processing circuits can receive, from a control device, an occupant response of an occupant from the space corresponding with the building condition and upon receiving a response (e.g., adjusting a thermostat, submitting a work order, or modifying lighting preferences) of an occupant to the building condition via a control device. Further, the AI model can be updated accordingly such that future adjustments better align with the identified comfort levels of the occupant. That is, updating can include adjusting tolerance thresholds (e.g., temperature setpoints, acceptable lighting levels, airflow limits) in the model based on the type and frequency of occupant responses. For example, the AI model can reduce HVAC output gradually during specific times if occupants indicate comfort at a wider temperature range. In some embodiments, the occupant response received from the control device can be received from at least one of a thermostat in the space or an application on a mobile device. Additionally, in some embodiments, the building condition can include various factors such as the temperature setpoint of the space, the lighting level within the space, specific air quality metrics of the space, the ventilation of the space, its humidity setpoint, and the outdoor air fraction pertaining to the space. As the conditions are subtly adjusted (e.g., lowering temperature incrementally, dimming lights, decreasing air flow, adjusting humidity levels), for example reducing lighting by 10 lux daily, occupant responses can be monitored. Upon reaching a threshold of an occupant where the occupant adjusts a setting such as a thermostat or reports discomfort, in some embodiments, occupants can then be informed and/or otherwise notified about the adjustments in the context of sustainability (e.g., to identify the limits of tolerable flexibility). For example, the processing circuits can store each threshold adjustment point and use these data points to refine setpoints across similar spaces within the building. In some embodiments, at least one (e.g., each) response of the occupant can be tracked and utilized to fine-tune the overall efficiency and comfort settings of the building. That is, the processing circuits can adjust future prompts or conditions based on response frequency and type, iteratively refining settings with each feedback instance. Additionally, the processing circuits can prompt, via the generative AI model on the mobile device, the occupant to reduce the building load including one or more recommendations to reduce the building load.

At block 925, the updated AI model can be utilized to generate one or more actions for the HVAC systems across multiple spaces within the building. That is, the processing circuits can analyze occupancy feedback to adjust the HVAC settings based on aggregated responses and tolerance levels across occupied zones. For example, the processing circuits can reduce temperature settings in areas where occupants consistently report comfort at lower temperatures, while maintaining higher settings in sparsely occupied zones. The actions can include, but are not limited to, updating the operating parameters of the HVAC system for at least one space, modifying the operating conditions of the HVAC system for at least one space, or adjusting the occupancy schedule of the building. In some embodiments, the AI model being used includes a generative large language model (LLM), with the LLM including a pretrained generative transformer model. That is, the processing circuits can use the LLM to interpret occupant feedback patterns, generating HVAC responses that align with overall occupancy trends and comfort thresholds. For example, a generative AI (GAI) model can be used to produce notifications prompting occupants to accept minor changes, such as raising the thermostat during high occupancy periods, to contribute to load reduction efforts.

In some embodiments, upon receiving an occupant response, the one or more processing circuits can present a prompt that corresponds to the building condition via a generative AI model on a control device. For example, if the temperature of the room goes beyond a certain threshold, the AI can prompt the occupant asking if they are comfortable or if an adjustment is needed. Another example can be during peak electricity usage hours, where if an occupant provides a response on the thermostat indicating the temperature is too warm, the system can prompt them with a message such as, “While it can feel slightly warmer than usual, maintaining this temperature can help the building save X % on energy load. Would you be willing to sustain this temperature for the next hour in the name of sustainability?” In some embodiments, the one or more processing circuits, through the generative AI model on the control device, receive an acceptance of the building condition. For example, upon being prompted, the occupant can confirm (e.g., by transmitting a message and/or any indication) their comfort with the current room conditions. In this example, after receiving the aforementioned sustainability message, an occupant can acknowledge and accept the warmer temperature, understanding the broader ecological benefit.

Furthermore, in some embodiments, the one or more processing circuits can maintain the building condition of the HVAC system of the space in the building at a designated time, t3. For example, after one or multiple confirmations of comfort from the occupants, the system can maintain a certain temperature or lighting level for a prolonged period. In this example, a user can provide responses, and the processing circuits can, responsive to the response, present, via a generative AI model on the control device, a prompt corresponding to the building condition. Additionally, the processing circuits can receive (e.g., via the generative AI model on the control device) an acceptance of the building condition. In some embodiments, the processing circuits can maintain the building condition of the HVAC system of the space in the building at a time t3. Additionally, in some embodiments, occupants are prompted by the one or more processing circuits via the generative AI model on a mobile device to reduce the building load. This can include one or more recommendations to reduce the building load, such as dimming the lights slightly or adjusting the temperature for energy conservation. Method 900 can also include collecting or receiving a variety of unstructured data, which can be related to multiple occupant responses associated with varying building conditions across several spaces in the building. In some embodiments, the AI model can trained using this diverse set of data. Specifically, updating the AI model can include retraining it based on new occupant responses. For example, if a majority of occupants express a preference for cooler temperatures during a specific time of day, the model can be retrained to anticipate and act on this preference in future scenarios.

In some embodiments, upon getting an occupant response, the processing circuits utilize the AI model to generate one or more actions for the HVAC system that align with updating the building condition. This can include adjusting airflow or humidity levels based on feedback. In some embodiments, the processing circuits can update a second building condition of the HVAC system for a different space in the building at times t4, t5, and t6. For example, the processing circuits can update (e.g., increase, decrease, or reset) a second building condition of the HVAC system of a second space in the building at a time t4. That is, the second building condition can be updated from the default building condition. In another example, the processing circuits can update the second building condition of the HVAC system of the space in the building at a time t5. In yet another example, the processing circuits can update (e.g., adjust, modify, or revert) the second building condition of an HVAC system of the space in the building at a time t6. Additionally, the plurality of occupant responses can include a plurality of tolerance responses (e.g., preferred temperature ranges, acceptable lighting levels, airflow preferences) of the plurality of occupants of the building associated with a setpoint of at least one of the plurality of spaces of the building. Additionally, the iterative process can be designed to fine-tune the building conditions based on feedback of a different occupant in a different space. That is, the processing circuits can adjust specific building conditions for each space based on the aggregated feedback, allowing each area to reflect occupant-specific comfort levels. For example, if a second occupant from a different space responds to the building condition, the AI model can be updated based on this new feedback, ensuring that individual spaces are tailored to the preferences of their respective occupants.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps can differ from what is depicted. Also two or more steps can be performed concurrently or with partial concurrence. Such variation will depend on the software and hardware systems chosen and on designer choice. All such variations are within the scope of the disclosure. Likewise, software embodiments can be accomplished with standard programming techniques with rule based logic and other logic to accomplish the various connection steps, processing steps, comparison steps and decision steps.

In various embodiments, the steps and operations described herein can be performed on one processor or in a combination of two or more processors. For example, in some embodiments, the various operations can be performed in a central server or set of central servers configured to receive data from one or more devices (e.g., edge computing devices/controllers) and perform the operations. In some embodiments, the operations can be performed by one or more local controllers or computing devices (e.g., edge devices), such as controllers dedicated to and/or located within a particular building or portion of a building. In various embodiments, first processors can be logically and/or physically distributed, interact, and/or be orchestrated by a second processor to achieve the targeted outcome(s). In some embodiments, the first processors are central. In some embodiments, the operations can be performed by a combination of one or more central or offsite computing devices/servers and one or more local controllers/computing devices. All such embodiments are contemplated within the scope of the present disclosure. Further, unless otherwise indicated, when the present disclosure refers to one or more computer-readable storage media and/or one or more controllers, such computer-readable storage media and/or one or more controllers can be implemented as one or more central servers, one or more local controllers or computing devices (e.g., edge devices), any combination thereof, or any other combination of storage media and/or controllers regardless of the location of such devices.

What is claimed is:

1. A method, comprising:
updating, by one or more processing circuits, a building condition of an HVAC system of a space in a building at a time t1, wherein the building condition is updated from a default building condition;
updating, by the one or more processing circuits, the building condition of the HVAC system of the space in the building at a time t2;
receiving, by the one or more processing circuits from a control device, an occupant response of an occupant from the space corresponding with the building condition;
updating, by the one or more processing circuits, an artificial intelligence (AI) model based on the occupant response; and
generating, by the one or more processing circuits using the AI model, one or more actions for the HVAC system of a plurality of spaces of the building.

2. The method of claim 1, wherein the one or more actions comprise at least one of updating an operating parameter of the HVAC system for at least a space of the plurality of spaces, updating an operating condition of the HVAC system for at least a space of the plurality of spaces, updating an occupancy schedule of the building.

3. The method of claim 1, wherein the AI model comprises a generative large language model (LLM), and wherein the generative LLM comprises a pretrained generative transformer model.

4. The method of claim 1, wherein the building condition comprises at least one of a temperature setpoint of the space, a level of lighting in the space, an air quality metric of the space, ventilation of the space, a humidity setpoint of the space, an outdoor air fraction of the space.

5. The method of claim 1, wherein the occupant response received from the control device is received from at least one of a thermostat in the space or an application on a mobile device.

6. The method of claim 5, further comprising:
in response to receiving the occupant response, presenting, by the one or more processing circuits via a generative AI model on the control device, a prompt corresponding to the building condition;
receiving, by the one or more processing circuits via the generative AI model on the control device, an acceptance of the building condition; and
maintaining, by the one or more processing circuits, the building condition of the HVAC system of the space in the building at a time t3.

7. The method of claim 6, further comprising:
prompting, by the one or more processing circuits via the generative AI model on the mobile device, the occupant to reduce a building load comprising one or more recommendations to reduce the building load.

8. The method of claim 1, further comprising:
collecting or receiving, by the one or more processing circuits, a plurality of unstructured data corresponding to a plurality of occupant responses associated with one or more building conditions of the plurality of spaces in the building; and
training, by the one or more processing circuits, the AI model using the plurality of unstructured data, wherein updating the AI model comprises retraining the AI model based on the occupant response.

9. The method of claim 8, wherein the plurality of occupant responses comprises a plurality of tolerance responses of the plurality of occupants of the building associated with a setpoint of at least one of the plurality of spaces of the building.

10. The method of claim 1, further comprising:
in response to receiving the occupant response, generating, by the one or more processing circuits using the AI model, one or more actions for the HVAC system corresponding with updating the building condition.

11. The method of claim 1, further comprising:
updating, by the one or more processing circuits, a second building condition of the HVAC system of a second space in the building at a time t4, wherein the second building condition is updated from the default building condition;
updating, by the one or more processing circuits, the second building condition of the HVAC system of the space in the building at a time t5;
updating, by the one or more processing circuits, the second building condition of an HVAC system of the space in the building at a time t6;
receiving, by the one or more processing circuits from a control device, a second occupant response of a second occupant from the second space corresponding with the second building condition; and
updating, by the one or more processing circuits, the AI model based on the second occupant response.

12. A building system of a building, the building system comprising one or more memory devices storing instructions thereon that, when executed by one or more processors, cause the one or more processors to:
update a building condition of an HVAC system of a space in a building at a time t1, wherein the building condition is updated from a default building condition;
update the building condition of the HVAC system of the space in the building at a time t2;
receive, from a control device, an occupant response of an occupant from the space corresponding with the building condition;
update an artificial intelligence (AI) model based on the occupant response; and
generate, using the AI model, one or more actions for the HVAC system of a plurality of spaces of the building.

13. The building system of claim 12, wherein the one or more actions comprise at least one of updating an operating parameter of the HVAC system for at least a space of the plurality of spaces, updating an operating condition of the HVAC system for at least a space of the plurality of spaces, updating an occupancy schedule of the building.

14. The building system of claim 12, wherein the AI model comprises a generative large language model (LLM), and wherein the generative LLM comprises a pretrained generative transformer model.

15. The building system of claim 12, wherein the building condition comprises at least one of a temperature setpoint of the space, a level of lighting in the space, an air quality metric of the space, ventilation of the space, a humidity setpoint of the space, an outdoor air fraction of the space.

16. The building system of claim 12, wherein the occupant response received from the control device is received from at least one of a thermostat in the space or an application on a mobile device.

17. The building system of claim 16, wherein the instructions when executed by the one or more processors, cause the one or more processors to:
in response to receiving the occupant response, present, via a generative AI model on the control device, a prompt corresponding to the building condition;
receive, via the generative AI model on the control device, an acceptance of the building condition; and
maintain the building condition of the HVAC system of the space in the building at a time t3.

18. The building system of claim 17, wherein the instructions when executed by the one or more processors, cause the one or more processors to:
prompt, via the generative AI model on the mobile device, the occupant to reduce a building load comprising one or more recommendations to reduce the building load.

19. The building system of claim 12, wherein the instructions when executed by the one or more processors, cause the one or more processors to:
collect or receive a plurality of unstructured data corresponding to a plurality of occupant responses associated with one or more building conditions of the plurality of spaces in the building; and
train the AI model using the plurality of unstructured data, wherein updating the AI model comprises retraining the AI model based on the occupant response.

20. A non-transitory computer readable medium storing instructions thereon that, when executed by one or more processors, cause the one or more processors to:
update a building condition of an HVAC system of a space in a building at a time t1, wherein the building condition is updated from a default building condition;
update the building condition of the HVAC system of the space in the building at a time t2;
receive, from a control device, an occupant response of an occupant from the space corresponding with the building condition;
update an artificial intelligence (AI) model based on the occupant response; and
generate, using the AI model, one or more actions for the HVAC system of a plurality of spaces of the building.
